(19) United States
(12) Patent Application Publication
(10) Pub. No.: US 2006/0285100 A1
(43) Pub. Date: Dec. 21, 2006

(54) Exposure apparatus and exposure method, and device manufacturing method

(75) Inventors: Masato Hamatani, Kounosu-shi (JP); Toshio Tsukakoshi, Ageo City (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Nikon Corporation, Chiyoda-ku (JP)

(21) Appl. No.: 11/449,694

(22) Filed: Jun. 9, 2006

Related U.S. Application Data
(63) Continuation-in-part of application No. 11/214,795, filed on Aug. 31, 2005.
Application No. 11/214,795 is a division of application No. 10/072,866, filed on Feb. 12, 2002, now Pat. No. 6,961,115.

(30) Foreign Application Priority Data
Feb. 13, 2001 (JP) 2001-036182
Feb. 13, 2001 (JP) 2001-036184
Feb. 26, 2001 (JP) 2001-051178
Jan. 31, 2002 (JP) 2002-023547
Jan. 31, 2002 (JP) 2002-023567

(51) Int. Cl. G03B 27/52

(52) U.S. Cl. 355/55; 355/53

(57) ABSTRACT

An exposure apparatus comprises: a movable body that is arranged on an image plane side with respect to a projection optical system; a wavefront measuring unit at least a part of which is arranged on the movable body and that measures wavefront information of the projection optical system; an adjusting unit that adjusts an imaging state of a projected pattern generated on an object via the projection optical system; and a controller that determines adjustment information of the projection optical system using the least-squares method based on the wavefront information and Zernike Sensitivity corresponding to exposure conditions of the object, and controls the adjusting unit based on the adjustment information. The controller determines a coefficient in a predetermined term of a Zernike polynomial from the wavefront information, and determines an adjustment amount of an optical element of the projection optical system as the adjustment information, based on data regarding a relation between an adjustment amount of the optical element of the projection optical system and variation of the determined coefficient in a predetermined term of a Zernike polynomial.

### CROSS-REFERENCE TO RELATED APPLICATIONS

This application is a continuation-in-part of U.S. application Ser. No. 11/214,795, filed Aug. 31, 2005, which is a divisional of Ser. No. 10/072,866, filed Feb. 12, 2002, the disclosure of each is hereby incorporated herein by reference in their entirety. This application also claims the benefit under 35 USC §119 of Japanese applications nos. 2001-036182, filed Feb. 13, 2001, 2001-036184, filed Feb. 13, 2001, 2001-051178, filed Feb. 26, 2001, 2002-023547, filed Jan. 31, 2002 and 2002-023567, filed Jan. 31, 2002, the disclosure of each is herein incorporated by reference.

### BACKGROUND OF THE INVENTION

1. Field of the Invention

The present invention relates to an exposure apparatus and an exposure method, and a device manufacturing method, and more specifically to an exposure apparatus and an exposure method that is used in a lithography process to manufacture semiconductor devices or the like, and a device manufacturing method in which the exposure method is used.

2. Description of the Related Art

In a lithography process for manufacturing semiconductor devices (CPU, DRAM, etc.), image picking-up devices (CCD, etc.), liquid crystal display devices, membrane magnetic heads or the like, exposure apparatuses have been used which form device patterns on a substrate. Because of increasingly high integration of semiconductor devices in these years, projection exposure apparatuses are mainly used such as a reduction projection exposure apparatus by a step-and-repeat method (the so-called stepper) that can form fine patterns on a substrate such as a wafer or glass plate with high throughput, a scan projection exposure apparatus by a step-and-scan method (the so-called scanning stepper) that is the improvement of the stepper.

In the process of manufacturing semiconductor devices, because multiple layers each of which has a sub-circuit pattern need to be overlaid and formed on a substrate, it is important to accurately align a reticle (or mask) having a sub-circuit pattern formed thereon with respect to the already-formed pattern in each shot area on a substrate. In order to accurately align, the optical properties of the projection optical system need to be precisely measured and adjusted to be in a desired state (for example, a state where magnification error of the transferred image of a reticle pattern relative to each shot area's pattern on the substrate is corrected). It is remarked that, also when transferring a reticle pattern for a first layer onto each shot area of the substrate, the imaging characteristic of the projection optical system is preferably adjusted in order to accurately transfer reticle patterns for the second and later layers onto each shot area.

Conventionally, as the method of measuring the optical properties (the imaging characteristic, etc.) of the projection optical system, a method is mainly used which calculates the optical properties based on the result of measuring a resist image obtained by exposing a substrate through a measurement reticle having a predetermined measurement pattern that remarkably responds to a specific aberration, formed thereon and then developing the substrate where a projected image of the measurement pattern is formed (the method being referred to as a “print method” hereinafter).

In exposure apparatuses of the prior art, measuring lower-order aberrations such as Seidel's five aberrations, i.e., spherical aberration, coma, astigmatism, field curvature, and distortion according to the print method and adjusting and managing the above aberrations due to the projection optical system based on the measurement result have been performed.

For example, when measuring distortion due to the projection optical system, a measurement reticle is used on which inner box marks that each are a square having a dimension of 100 μm and outer box marks that each are a square having a dimension of 200 μm are formed, and after having transferred the inner or outer box marks onto a wafer whose surface is coated with a resist through the projection optical system, the wafer stage is moved and then the other marks are transferred and overlaid onto the wafer through the projection optical system. When the magnification is equal to ⅕ for example, the resist image of box-in-box marks appears, after development of the wafer, in each of which a box mark having a dimension of 20 μm is located inside of a box mark having a dimension of 40 μm. And distortion due to the projection optical system is detected by measuring the positional relation between both the marks and deviation from their reference point in the stage coordinate system.

Moreover, when measuring the coma of the projection optical system, a measurement reticle is used on which a line-and-space pattern (hereinafter, referred to as a “L/S”) having five lines whose width is, for example, 0.9 μm is formed, and the pattern is transferred onto a wafer whose surface is coated with a resist through the projection optical system. When the magnification is equal to ⅕ for example, the resist image of the L/S pattern appears having a line width of 0.18 μm, after development of the wafer. And coma due to the projection optical system is detected by measuring the widths L1, L5 of two lines in both ends of the pattern and obtaining a line-width abnormal value given by the following equation.
the line-width abnormal vale=(L1−L5)/(L1+L5) (1)

Moreover, for example, in measuring a best focus position of the projection optical system, a wafer is moved sequentially to a plurality of positions along the optical axis direction which are a given distance (step pitch) apart from each other, and the L/S pattern is transferred each time onto a different area of the wafer through the projection optical system. The wafer position associated with one whose line width is maximal out of the resist images of the L/S pattern, which appear after development of the wafer, is adopted as the best focus position.

When measuring the spherical aberration, the measurement of a best focus position is performed a plurality of times each time with a different L/S pattern having a different duty ratio, and based on the differences between the best focus positions, the spherical aberration is obtained.

When measuring the field curvature, the measurement of a best focus position is performed in a plurality of measurement points within the field of the projection optical system, and based on the measurement results, the field curvature is calculated using the least-squares method.

In addition, when measuring the astigmatism due to the projection optical system, the measurement of a best focus position is performed with two kinds of periodic patterns whose period directions are perpendicular to each other, and based on the difference between the best focus positions, the astigmatism is calculated.

In the prior art, the specification of a projection optical system in the making of an exposure apparatus is determined according to the same standard as in the above managing of the optical properties of the projection optical system. That is, the specification is determined such that the five aberrations measured by the print method or obtained by a simulation substantially equivalent thereto are equal to or less than respective predetermined values.

However, because of the demand for further improved exposure accuracy corresponding to increasingly high integration in these years, measuring only the lower-order aberrations according to the prior art method and, based on the measurement result, adjusting the optical properties of the projection optical system does not yield a desired result. The reason for that is as follows.

The aerial image of a measurement pattern, for example, a L/S pattern has space-frequency components (intrinsic frequency components), i.e. a fundamental wave corresponding to the L/S period and higher harmonics, and the pattern determines the space-frequencies of the components that pass through the pupil plane of the projection optical system. Meanwhile, reticles having various patterns are used in the actual manufacturing of devices, the aerial images of which patterns include innumerable space-frequency components. Therefore, the prior art method of measuring and adjusting aberrations based on the limited information hardly meet the demand for further improved exposure accuracy.

In this case, although reticle patterns having intrinsic frequency components that are missing in the information need to be measured, it takes an enormous amount of measurement and time, so that it is not practical.

Furthermore, because of the accuracy in measuring resist images, which are affected by the measurement accuracy and the intrinsic characteristic of the resist, etc., the correlation between the resist image and a corresponding optical image (aberration) needs to be found before extracting data from the measurement result.

Furthermore, when an aberration is large, the linearity of the resist image to the corresponding aerial image of the pattern is lost, so that accurate measurement of the aberration is difficult. In this case, for the purpose of accurately measuring the aberration, it is necessary to change the pattern-pitch, the line width (space frequency), etc., of the measurement pattern of the reticle, through trial and error, such that the intrinsic characteristic of the resist can be measured (the linearity is obtained).

For the same reason, the method of determining the specification of a projection optical system according to the above criteria has reached its limit. It is because a projection optical system satisfying the specification determined obviously cannot achieve exposure accuracy demanded at present and in the future.

In such circumstances, the adjusting method has been adopted where, when making a projection optical system according to the specification determined, the positions, etc., of lens elements are adjusted such that the Seidel's five aberrations (lower-order aberrations) satisfy the determined specification, based on the result of measuring the aberration due to the projection optical system according to the print method after the assembly of the projection optical system in the making process, and, after that, detecting residual higher-order aberrations by a ray-tracing method and adjusting the positions, etc., of lens elements in the projection optical system (additionally reprocessing such as non-spherical-surface process, if necessary) are performed (refer to Kokai (Japanese Unexamined Patent Application Publication) No. 10-154657).

However, the above method of making a projection optical system needs the two steps of correcting lower-order aberrations and correcting higher-order aberrations and also computation for ray-tracing that even super-computer will take several days to perform.

Furthermore, when an aberration (non-linear aberration) occurs by which the linearity of the resist image to the corresponding aerial image of a pattern is lost, adjusting the projection optical system in view of the order in which aberrations are adjusted is needed. For example, when coma is large, the image of a pattern is not resolved, so that accurate data of distortion, astigmatism and spherical aberration cannot be obtained. Therefore, it is necessary to measure coma using a pattern for accurate measurement of coma and adjust the projection optical system to make the coma small enough and then measure distortion, astigmatism and spherical aberration and, based on the measurement result, adjust the projection optical system. The fact that the order of measuring the aberrations to be adjusted is specified means that the selection of the lenses used is restricted.

In addition, the prior art method uses, regardless of what maker the user of the exposure apparatus is, measurement patterns suitable to measure the respective aberrations (the patterns remarkably responding to the respective aberrations) in order to determine the specification of the projection optical system and adjust the optical properties.

Meanwhile, the effects that the aberrations due to the projection optical system have on the imaging characteristic for various patterns are different. For example, contact-hole features are more influenced by astigmatism than by the others while a fine line-and-space pattern is more influenced by coma than by the others. Furthermore, the best focus position is different between an isolated line pattern and a line-and-space pattern.

Therefore, the optical properties (aberrations, etc.) of the projection optical system and other capabilities of an exposure apparatus actually differ between its users.

### SUMMARY OF INVENTION

This invention was made under such circumstances, and a first purpose of the present invention is to provide an exposure apparatus that can transfer a pattern onto an object with good precision via a projection optical system.

Further, a second purpose of the present invention is to provide an exposure method in which a pattern can be transferred onto an object with good precision via a projection optical system.

In addition, a third purpose of the present invention is to provide a device manufacturing method that contributes improvement of the productivity of devices.

According to a first aspect of the present invention, there is provided an exposure apparatus that transfers a pattern onto an object via a projection optical system, the apparatus comprising: a movable body that is arranged on an image plane side with respect to the projection optical system; a wavefront measuring unit at least a part of which is arranged on the movable body and that measures wavefront information of the projection optical system; an adjusting unit that adjusts an imaging state of a projected pattern generated on the object via the projection optical system; and a controller that controls the adjusting unit using the wavefront information and Zernike Sensitivity corresponding to exposure conditions of the object.

According to a second aspect of the present invention, there is provided an exposure method in which a pattern is transferred onto an object via a projection optical system, the method comprising: measuring wavefront information of the projection optical system with a wavefront measuring unit at least a part of which is arranged on a movable body and that is arranged on an image plane side with respect to the projection optical system; and adjusting an imaging state of a pattern generated on the object via the projection optical system using the wavefront information and Zernike Sensitivity corresponding to exposure conditions of the object.

In addition, in a lithography process, by performing exposure using the exposure apparatus of the present invention, a pattern can accurately be formed on an object, which makes it possible to manufacture highly integrated microdevices with high yield. Therefore, according to another aspect of the present invention, there is provided a device manufacturing method in which the exposure apparatus of the present invention is used. In addition, in a lithography process, by performing exposure using the exposure method of the present invention, a pattern can accurately be formed on a photosensitive object. Therefore, further according to another aspect of the present invention, there is provided a device manufacturing method in which the exposure method of the present invention is used (i.e. a device manufacturing method including a process in which a pattern is transferred onto an object using the exposure method).

### BRIEF DESCRIPTION OF THE DRAWINGS

In the accompanying drawings:

FIG. 1 is a schematic view showing the construction of a computer system according to an embodiment of this invention;

FIG. 2 is a schematic view showing the construction of a first exposure apparatus 122₁ in FIG. 1;

FIG. 3 is a cross-sectional view of an exemplary wavefront-aberration measuring unit;

FIG. 4A is a view showing light beams emitted from microlens array when there is no aberration in the optical system;

FIG. 4B is a view showing light beams emitted from microlens array when there is aberration in the optical system;

FIGS. 5A to 5F are views for explaining a definition of drive directions of movable lenses or the like that are driven on the making of a database;

FIG. 6 is a flowchart showing a process algorithm executed by a CPU in the second communication server when setting best exposure conditions of an exposure apparatus;

FIG. 7 is a schematic, oblique view of a measurement reticle;

FIG. 8 is a schematic view showing an X-Z cross-section, near the optical axis AX, of the measurement reticle mounted on a reticle stage along with a projection optical system;

FIG. 9 is a schematic view showing an X-Z cross-section of the −Y direction end of the measurement reticle mounted on a reticle stage along with the projection optical system;

FIG. 10A is a view showing a measurement pattern formed on the measurement reticle in the embodiment;

FIG. 10B is a view showing a reference pattern formed on the measurement reticle in the embodiment;

FIG. 11 is a flowchart schematically showing a control algorithm of a CPU in a main controller for measurement of an imaging characteristic and display (simulation);

FIG. 12 is a flowchart showing a processing in subroutine 126 of FIG. 8;

FIG. 13A is a view showing one of reduced images (latent images) of the measurement pattern formed a given distance apart from each other on the resist layer on a wafer;

FIG. 13B is a view showing the positional relation between the latent image in FIG. 13A of the measurement pattern and the latent image of the reference pattern;

FIG. 14 is a flowchart schematically showing the process of making the projection optical system; and

FIG. 15 is a schematic view showing the construction of a computer system modified.

### DETAILED DESCRIPTION OF THE PREFERRED EMBODIMENTS

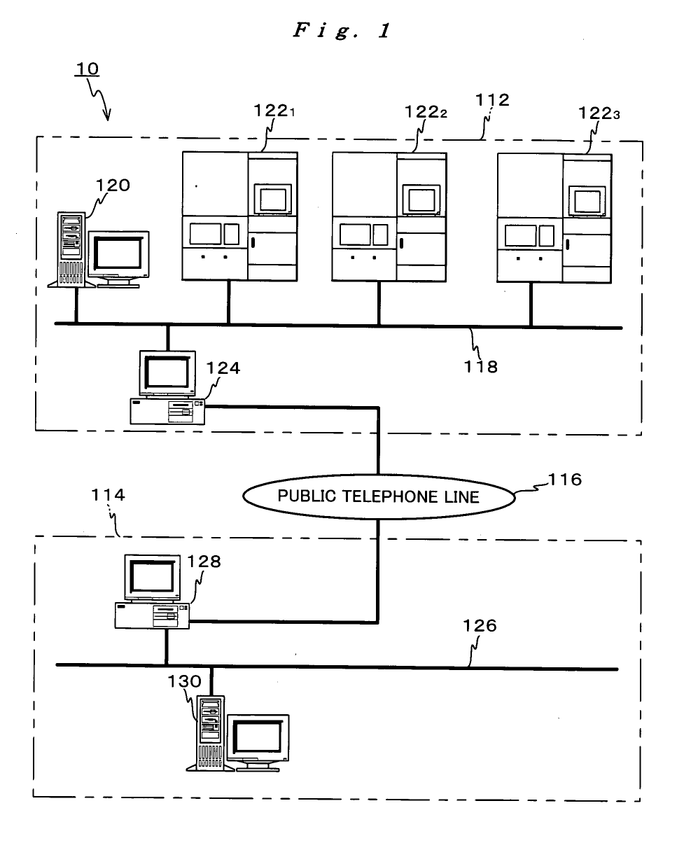

An embodiment of the present invention will be described below based on FIGS. 1 to 14.

FIG. 1 shows the schematic construction of a computer system according to an embodiment of this invention.

A computer system 10 shown in FIG. 1 comprises a lithography system 112 in a semiconductors-manufacturing factory of a device maker (hereinafter, called “maker A” as needed), which is a user of a device manufacturing apparatus such as an exposure apparatus, and a computer system 114 of an exposure apparatus maker (hereinafter, called “maker B” as needed) connected via a communication line including public telephone line 116 to part of lithography system 112.

Lithography system 112 comprises a first communication server 120 as a first computer, a first, second and third exposure apparatuses 122₁, 122₂, 122₃ as optical apparatuses, a first proxy server 124 for verification, and the like, all of which are connected with each other via a local area network (LAN) 118.

First communication server 120 and first through third exposure apparatuses 122₁, 122₂, 122₃ are assigned addresses AD1 through AD4 with which to distinguish them respectively.

First proxy server 124 is provided between LAN 118 and public telephone line 116 and serves as a kind of firewall. That is, first proxy server 124 prevents communication data flowing through LAN 118 from leaking to the outside, allows only information from the outside having one of addresses AD1 through AD4 to pass through it and blocks the passage of other information, so that LAN 118 is protected against unjust invasion from the outside.

The computer system 114 comprises a second proxy server 128 for verification, a second communication server 130 as a second computer and the like, all of which are connected with each other via a local area network (LAN) 126. Second communication server 130 is assigned an address AD5 with which to identify it.

Second proxy server 128, in the same way as first proxy server 124, prevents communication data flowing through LAN 126 from leaking to the outside and serves as a kind of firewall that protects LAN 126 against unjust invasion from the outside.

In this embodiment, data from first through third exposure apparatuses 122₁, 122₂, 122₃ is transferred to the outside via first communication server 120 and first proxy server 124, and data to first through third exposure apparatuses 122₁, 122₂, 122₃ is transferred from the outside via first proxy server 124 or via first proxy server 124 and first communication server 120.

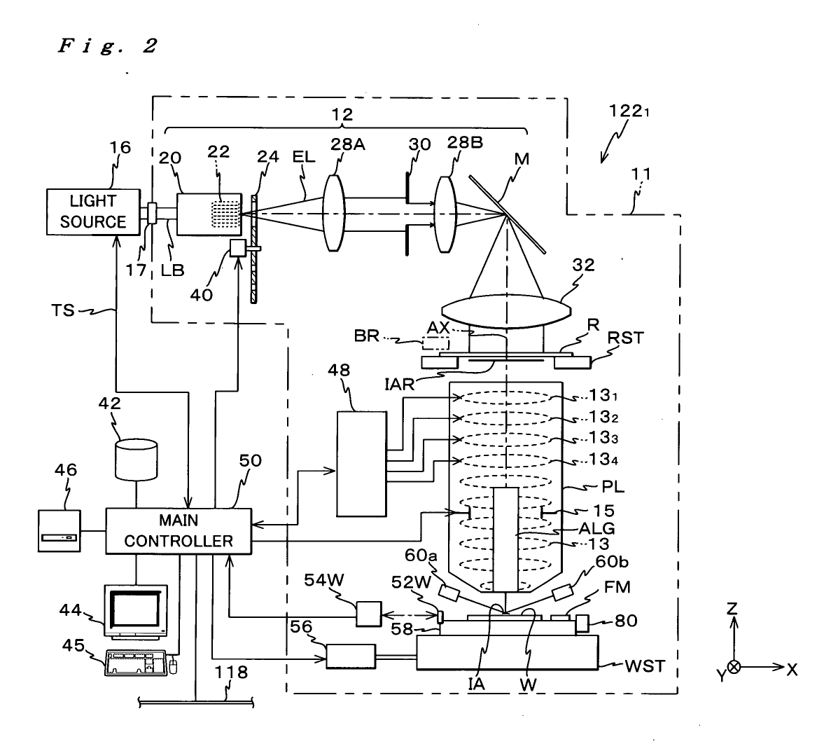

FIG. 2 shows the schematic construction of first exposure apparatus 122₁, which is a reduction projection exposure apparatus by a step-and-repeat method, i.e. a stepper, using a pulse-laser light source as an exposure light source (hereinafter, called a “light source”).

Exposure apparatus 122₁ comprises an illumination system composed of a light source 16 and illumination optical system 12, a reticle stage RST holding a reticle R illuminated with exposure illumination light EL as an energy beam from the illumination system, a projection optical system PL as an exposure optical system, which projects exposure illumination light EL from reticle R onto a wafer W which is on the image plane, a wafer stage WST on which a Z-tilt stage 58 for holding wafer W is mounted, a control system for controlling these, and the like.

Light source 16 is a pulse-ultraviolet light source that emits pulse light having a wavelength in the vacuum-ultraviolet range such as F₂ laser (a wavelength of 157 nm) or ArF excimer laser (a wavelength of 193 nm). Alternatively light source 16 may be a light source that emits pulse light having a wavelength in the far-ultraviolet or ultraviolet range such as KrF excimer laser (a wavelength of 248 nm).

Light source 16 is disposed, in practice, in a service room having low cleanliness that is separate from a clean room where a chamber 11 housing an exposure-apparatus main body composed of various elements of illumination optical system 12, reticle stage RST, projection optical system PL, wafer stage WST, etc., is disposed, and is connected to chamber 11 via a light-transmitting optical system (not shown) including at least part of an optical-axis adjusting optical system called a beam-matching unit. Light source 16 is controlled by an internal controller thereof according to control-information TS from a main controller 50 in terms of switching the output of laser beam LB, the energy of laser beam LB per pulse, output-frequency (pulse frequency), the center wavelength and half band width in spectrum (width of the wavelength range) and the like.

Illumination optical system 12 comprises a beam-shaping, illuminance-uniformalizing optical system 20 having a cylinder lens, a beam expander (none are shown), and an optical integrator (homogenizer) 22 therein, an illumination-system aperture stop plate 24, a first relay lens 28A, a second relay lens 28B, a reticle blind 30, a mirror M for deflecting the optical path, a condenser lens 32 and the like. The optical integrator is a fly-eye lens, a rod-integrator (inner-side-reflective-type integrator) or a diffracting optical element. In this embodiment a fly-eye lens is used as an optical integrator 22, which is also referred to as a fly-eye lens 22.

Beam-shaping, illuminance-uniformalizing optical system 20 is connected through a light transmission window 17 provided on chamber 11 to the light-transmitting optical system (not shown), and gets the cross section of laser beam LB, which is incident thereon through light transmission window 17 from light source 16, to be shaped by the cylinder lens or beam expander, for example. Fly-eye lens 22 in the exit side of beam-shaping, illuminance-uniformalizing optical system 20 forms, from the laser beam having its cross-section shaped, a surface illuminant (secondary illuminant) composed of a lot of point illuminants (illuminant images) on the focal plane on the output side, which plane substantially coincides with the pupil plane of illumination optical system 12 in order to illuminate reticle R with uniform illuminance. The laser beam emitted from the secondary illuminant is called “illumination light EL” hereinafter.

Illumination-system aperture stop plate 24 constituted by a disk-like member is disposed near the focal plane on the exit side of fly-eye lens 22. And arranged at almost regular pitches along a circle on illumination-system aperture stop plate 24 are, e.g., a usual aperture stop (usual stop) constituted by a circular opening, a aperture stop (small-σ stop) for making coherence factor σ small which is constituted by a small, circular opening, a ring-like aperture stop (ring stop) for forming a ring of illumination light, and a deformation aperture stop for a deformation illuminant method composed of a plurality of openings arranged eccentrically, of which two types of aperture stops are shown in FIG. 2. Illumination-system aperture stop plate 24 is constructed and arranged to be rotated by a driving unit 40 such as a motor controlled by main controller 50, and one of the aperture stops is selectively set to be on the optical path of illumination light EL, so that the shape of the illuminant surface in Koehler illumination described later is a ring, a small circle, a large circle, four eyes or the like.

Instead of aperture stop plate 24 or in combination with it, for example, a plurality of diffracting optical elements disposed in the illumination optical system, a movable prism (conical prism, polyhedron prism, etc.) along the optical axis of the illumination optical system, and an optical unit comprising at least one zoom optical system are preferably arranged between light source 16 and optical integrator 22, and by making variable, when optical integrator 22 is a fly-eye lens, the intensity distribution of the illumination light on the incidence surface thereof or, when optical integrator 22 is an inner-face-reflective-type integrator, the range of incidence angle of the illumination light to the incidence surface, light-amount distribution (the size and shape of the secondary illuminant) of the illumination light on the pupil plane of the illumination optical system is preferably adjusted, that is, loss of light due to the change of conditions for illuminating reticle R is preferably suppressed. It is noted that in this embodiment a plurality of illuminant images (virtual images) formed by the inner-face-reflective-type integrator are also referred to as a secondary illuminant.

Disposed on the optical path of illumination light EL from illumination-system aperture stop plate 24 is a relay optical system composed of first and second relay lenses 28A, 28B, between which reticle blind 30 is disposed. Reticle blind 30, in which a rectangular opening for defining a rectangular illumination area IAR on reticle R is made, is disposed on a plane conjugate to the pattern surface of reticle R, and is a blind whose opening is variable in shape and set by main controller 50 based on blind-setting information also called masking information.

Disposed on the optical path of illumination light EL behind second relay lens 28B forming part of the relay optical system is deflecting mirror M for reflecting illumination light EL having passed through second relay lens 28B toward reticle R, and on the optical path of illumination light EL behind mirror M, condenser lens 32 is disposed.

In the construction described above, the incidence surface of fly-eye lens 22, the plane on which reticle blind 30 is disposed, and the pattern surface of reticle R are optically conjugate to each other, while the illuminant surface formed on the focal plane on the exit side of fly-eye lens 22 (the pupil plane of the illumination optical system) and the Fourier transform plane of projection optical system PL (the exit pupil plane) are optically conjugate to each other, and these form a Koehler illumination system.

The operation of the illumination optical system having the above construction will be described briefly in the following. Laser beam LB emitted in pulse out of light source 16 is made incident on beam-shaping, illuminance-uniformalizing optical system 20 which shapes the cross section thereof, and then is made incident on fly-eye lens 22. By this, the secondary illuminant is formed on the focal plane on the exit side of fly-eye lens 22.

Illumination light EL emitted out of the secondary illuminant passes through an aperture stop on illumination-system aperture stop plate 24, first relay lens 28A, the rectangular aperture of reticle blind 30, and second relay lens 28B in that order and then is deflected vertically and toward below by mirror M and, after passing through condenser lens 32, illuminates rectangular illumination area IAR on reticle R held on reticle stage RST.

A reticle R is loaded onto reticle stage RST and is held by electrostatic chuck, vacuum chuck or the like (not shown). Reticle stage RST is constructed to be able to be finely driven (including rotation) on a horizontal plane (an X-Y plane) by a driving system (not shown). It is remarked that the position of reticle stage RST is measured by a position detector (not shown) such as a reticle laser interferometer with predetermined resolution (e.g., 0.5 to 1 nm) to supply the measurement results to main controller 50.

It is noted that the material for reticle R depends on the light source used. That is, when ArF excimer laser or KrF excimer laser is used as the light source, synthetic quartz, fluoride crystal such as fluorite, fluorine-doped quartz or the like can be used while, when F₂ laser is used as the light source, fluoride crystal such as fluorite, fluorine-doped quartz or the like needs to be used.

Projection optical system PL is, for example, a both-side telecentric reduction system, and the projection magnification of projection optical system PL is, e.g., ¼, ⅕ or ⅙. Therefore, when illumination area IAR on reticle R is illuminated with illumination light EL as is described above, the image of the pattern on reticle R is reduced to the projection magnification times the original size and projected and transferred by projection optical system PL onto a rectangular exposure area IA (usually coincides with a shot area) on a wafer W coated with a resist (photosensitive agent).

Projection optical system PL is a dioptric system composed of only a plurality (e.g. about 10 to 20) of dioptric elements (lens elements) 13, ones, as shown in FIG. 2. A plurality of lens elements 13₁, 13₂, 13₃, 13₄ (considering four lens elements for the sake of brief description) on the object plane side (reticle R side) of projection optical system PL out of the plurality of lens elements 13 are movable lenses that can be driven by an imaging-characteristic correcting controller 48. Lens elements 13₁ through 13₄ are held in a lens-barrel via double-structured lens holders (not shown) respectively. Lens elements 13₁, 13₂, 13₄ of these are held by inner lens holders each of which is supported at three points against a respective outer lens holder by driving devices (not shown) such as piezo devices. By independently adjusting the voltages applied to the driving devices, lens elements 13₁, 13₂, 13₄ can be shifted in a Z-direction, the optical axis direction of projection optical system PL and tilted relative to the X-Y plane, that is, rotated around the X- and Y-axes. Lens element 13₃ is held by an inner lens holder (not shown), and between the outer-circle side face of the inner lens holder and the inner-circle side face of the outer lens holder, driving devices such as piezo devices are disposed at almost regular pitches each of which covers an angle of, e.g., 90 degrees. And adjusting the voltages applied to two opposite driving devices lens element 13₃ can be shifted two-dimensionally in the X-Y plane.

Other lens elements 13 are held in the lens-barrel via a usual lens holder. It is noted that not being limited to lens elements 13₁ through 13₄, lenses near the pupil plane or in the image plane side of projection optical system PL, or an aberration-correcting plate (optical plate) for correcting aberration in projection optical system PL, especially non-rotation-symmetry component thereof, may be constructed to be able to be driven. Furthermore, the degree of freedom of those optical elements (the number of directions in which to be movable) may be one or more than three, not being limited to two or three.

Moreover, near the pupil plane of projection optical system PL, a pupil aperture stop 15 whose numerical aperture (N.A.) is variable continuously in a predetermined range is disposed. As pupil aperture stop 15, for example, a so-called iris aperture stop is used. Pupil aperture stop 15 is controlled by main controller 50.

It is noted that the material for the lens elements of projection optical system PL is fluoride crystal such as fluorite, fluorine-doped quartz, synthetic quartz, or the like when ArF excimer laser or KrF excimer laser is used as illumination light EL or, when F₂ laser is used, fluoride crystal such as fluorite or fluorine-doped quartz.

Wafer stage WST is constructed to be driven freely on the X-Y two-dimensional plane by a wafer-stage driving portion 56 including a linear motor, and on a Z-tilt stage 58 mounted on wafer stage WST, a wafer W is held via a wafer holder (not shown) by electrostatic chuck, vacuum chuck or the like.

Furthermore, Z-tilt stage 58 is constructed to be able to be positioned in the X-Y plane on wafer stage WST and to be tilted relative to the X-Y plane as well as to be movable in the Z-direction so that the surface of a wafer W held on Z-tilt stage 58 can be set at a specified position (position in the Z-direction and tilt to the X-Y plane).

Moreover, fixed on Z-tilt stage 58 is a movable mirror 52W, through which a wafer laser interferometer 54W externally disposed measures the position in an X-axis direction, a Y-axis direction and a θz direction (a rotation direction around a Z-axis) of Z-tilt stage 58, and the position in a θy direction (a rotation direction around a Y-axis) and a θx direction (a rotation direction around an X-axis) of Z-tilt stage 58, and position information measured by wafer laser interferometer 54W is supplied to main controller 50, which controls wafer stage WST (and Z-tilt stage 58) based on the position information via wafer-stage driving portion 56 (including the driving systems of wafer stage WST and Z-tilt stage 58).

A fiducial mark plate FM having fiducial marks such as fiducial marks for baseline measurement is disposed on Z-tilt stage 58 such that the surface thereof substantially coincides in height with the surface of wafer W.

A wavefront-aberration measuring unit 80 that is attachable and detachable and portable is disposed on the side face in the +X direction of Z-tilt stage 58 (right side of the drawing of FIG. 2).

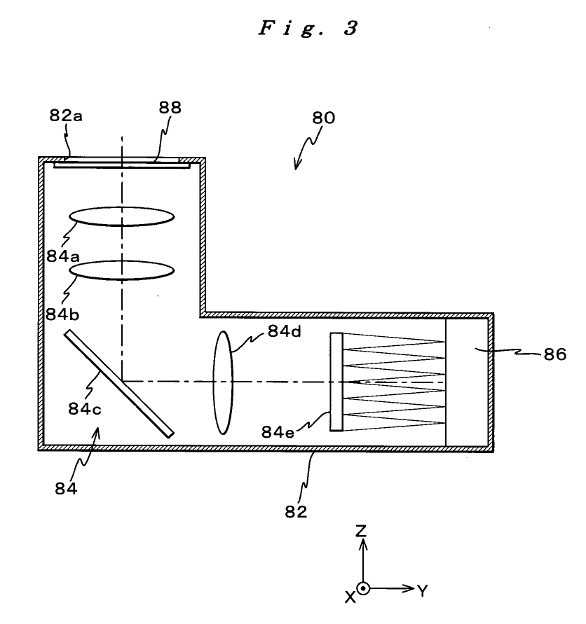

Wavefront-aberration measuring unit 80, as shown in FIG. 3, comprises a housing 82, a light-receiving optical system 84 composed of a plurality of optical elements arranged in a predetermined positional relation in housing 82, and a light-receiving portion 86 arranged in the end in the +Y direction of housing 82.

The cross section along the Y-Z plane of housing 82 having a space therein is shaped like an “L”, and in the topside (in the +Z direction) thereof, an opening 82a which is circular in a plan view is made so that light from above housing 82 can be made incident through it. Furthermore, a cover glass 88 is provided so as to cover opening 82a from inside housing 82. Formed on the upper surface of cover glass 88 by deposition of metal such as chrome is a shielding membrane having a circular opening in the center thereof, which stops unnecessary light from entering light-receiving optical system 84 in measuring wavefront aberration due to projection optical system PL.

Light-receiving optical system 84 comprises an objective lens 84a, a relay lens 84b, and a deflecting mirror 84c, which are arranged in that order from under cover glass 88 in housing 82, and a collimator lens 84d and a microlens array 94e, which are arranged in that order on the +Y side of deflecting mirror 84c. Deflecting mirror 84c is fixed to make an angle of 45 degrees with the Z- and Y-directions so that light incident vertically from above on objective lens 84a is deflected toward collimator lens 84d. It is noted that the optical elements of light-receiving optical system 84 are fixed on the inner wall of housing 82 via holding members (not shown). Microlens array 84e has a plurality of small convex lenses (lens elements) arranged in an array on a plane perpendicular to the optical path.

Light-receiving portion 86 comprises a light-receiving device such as two-dimensional CCD and an electric circuit such as a charge-transfer controlling circuit. The light-receiving device has a size enough to receive all rays of light sent from microlens array 84e after having passed through objective lens 84a. Data measured by light-receiving portion 86 is sent to main controller 50 via a signal line (not shown) or by radio.

Wavefront-aberration measuring unit 80 can measure the wavefront aberration due to projection optical system PL while projection optical system PL is fixed in the exposure-apparatus main body. The method of measuring the wavefront aberration due to projection optical system PL by using wavefront-aberration measuring unit 80 will be described later.

Referring back to FIG. 2, exposure apparatus 122₁ further comprises an oblique incidence type of multi-focus-position detection system composed of a light source switched by main controller 50, an irradiation system 60a for sending out imaging beams, which form a lot of pinhole or slit images, toward the image plane of projection optical system PL and in an oblique direction to the optical axis AX, and a light-receiving system 60b for receiving the imaging beams reflected by the surface of wafer W, the multi-focus-position detection system being simply called a “focus detection system” hereinafter. The focus detection system (60a, 60b) has the same construction as is disclosed in, for example, Kokai (Japanese Unexamined Patent Application Publication) No. 6-283403 and U.S. Pat. No. 5,448,332 corresponding thereto. The disclosure in the above U.S. Patent is incorporated herein by reference.

Main controller 50, upon exposure and the like, controls the Z-position and the tilt relative to the X-Y plane of wafer W via wafer-stage driving portion 56 based on the focus deviation signal (defocus signal) such as an S-curve signal from light-receiving system 60b such that the focus deviation becomes zero, by which auto-focus and auto-leveling are performed. Further main controller 50 measures the Z-position of wavefront-aberration measuring unit 80 and positions it by using the focus detection system (60a, 60b) when measuring the wavefront aberration as described later. Here, the tilt of wavefront-aberration measuring unit 80 may also be measured, if necessary.

Exposure apparatus 122₁ further comprises an alignment system ALG of an off-axis type for measuring the positions of, e.g., alignment marks on a wafer W held on wafer stage WST and the fiducial mark formed on the fiducial mark plate FM. Alignment system ALG is an FIA (Field Image Alignment) sensor of an image-processing type which directs, e.g., a detection beam whose frequency band is broad for resist on the wafer not to sense to a target mark and which picks up images of the target mark formed on the receiving plane by the beam reflected from the target mark and an index (not shown), by a pick-up device (CCD, etc.) with outputting the pick-up signals thereof. Not being limited to the FIA system, an alignment sensor which directs a coherent detection beam to a target mark and detects the beam scattered or diffracted from the target mark or an alignment sensor which detects the interference of two order sub-beams (e.g., of the same order) diffracted from the target mark or the combination of the two may be used, needless to say.

Moreover, above reticle R in exposure apparatus 122₁ in the embodiment, a pair of reticle alignment microscopes (not shown) each constituted by a TTR (Through The Reticle) alignment optical system for simultaneously observing a reticle mark on reticle R and a corresponding fiducial mark on the fiducial mark plate through projection optical system PL using light having the same wavelength as exposure light are provided. The reticle alignment microscope has the same construction as is disclosed in, for example, Kokai (Japanese Unexamined Patent Application Publication) No. 7-176468 and U.S. Pat. No. 5,646,413 corresponding thereto. The disclosure in the above U.S. Patent is incorporated herein by reference.

The control system includes main controller 50 in FIG. 2 which is constituted by a work station (or microcomputer) comprising a CPU (Central Processing Unit), ROM (Read Only Memory), RAM (Random Access Memory), etc., and which controls the entire apparatus overall as well as the above operations. Main controller 50 controls between-shots stepping of wafer stage WST, exposure timing and the like overall.

Furthermore, for example, a storage unit 42 constituted by hard disks, an input unit 45 comprising a pointing-device such as the mouse, a display unit 44 such as a CRT display or liquid-crystal display, and a drive unit 46 for information-recording media such as CD-ROM, DVD-ROM, MO, FD, etc., are externally connected to main controller 50. And main controller 50 is connected with LAN 118.

An information-recording medium provided in drive unit 46 (hereinafter, CD-ROM for the sake of convenience) stores a conversion program (hereinafter, called a “first program” for the sake of convenience) for converting a position deviation amount measured by wavefront-aberration measuring unit 80 as described later (or measured using a measurement reticle R_{T} to be described later) into coefficients of the Zernike polynomial.

Second and third exposure apparatuses 122₂, 122₃ have the same construction as first exposure apparatus 122₁.

Next, the method of measuring wavefront aberration in first to third exposure apparatus 122₁ to 122₃ upon maintenance, etc., will be described assuming for the sake of simplicity that the wavefront aberration due to light-receiving optical system 84 of wavefront-aberration measuring unit 80 is negligible.

As a premise, it is supposed that the first program of the CD-ROM in drive unit 46 has been installed in storage unit 42.

Upon usual exposure operation, because wavefront-aberration measuring unit 80 is detached from Z-tilt stage 58, a service engineer, operator or the like (hereinafter, called “service engineer, etc.,” as needed) first attaches wavefront-aberration measuring unit 80 to the side face of Z-tilt stage 58. Here, wavefront-aberration measuring unit 80 is fixed on a predetermined reference surface (herein, the side face in the +X direction) by bolts, magnets or the like, so that wavefront-aberration measuring unit 80 can be put in place within the stroke distance of wafer stage WST (Z-tilt stage 58) when measuring the wavefront aberration.

After the completion of the attaching, main controller 50, according to a measurement-start command inputted by the service engineer, etc., moves wafer stage WST via wafer-stage driving portion 56 such that wavefront-aberration measuring unit 80 is put underneath alignment system ALG, detects an alignment mark (not shown) provided on wavefront-aberration measuring unit 80 by alignment system ALG, and, based on the detection result and values measured at the same time by laser interferometer 54W, calculates the position coordinates of the alignment mark to obtain the accurate position of wavefront-aberration measuring unit 80. And after the measuring of wavefront-aberration measuring unit 80's position, main controller 50 measures the wavefront aberration in the manner described below.

Main controller 50 loads a measurement reticle, on which pinhole features are formed, (not shown; called a “pinhole reticle” hereinafter) onto reticle stage RST by a reticle loader (not shown). The pinhole reticle is a reticle on the pattern surface of which pinholes are formed in a plurality of points within an area identical to illumination area IAR, each of the pinholes being an ideal point illuminant and producing a spherical wave.

It is noted that a diffusing surface, for example, is provided on the upper surface of the pinhole reticle so that the wavefront of the beam passing through projection optical system PL and the wavefront-aberration can be measured for all N.A.'s of projection optical system PL.

After loading the pinhole reticle, main controller 50 detects the reticle alignment mark of the pinhole reticle by the reticle alignment microscopes and, based on the detection result, positions the pinhole reticle in a predetermined position, so that the center of the pinhole reticle almost coincides with the optical axis of projection optical system PL.

After that, main controller 50 gives control information TS to light source 16 to make it generate laser beam LB. By this, the pinhole reticle is illuminated with illumination light EL from illumination optical system 12. Then light from each of the plurality of pinholes of the pinhole reticle is focused through projection optical system PL on the image plane to form a pinhole image.

Next, main controller 50 moves wafer stage WST via wafer-stage driving portion 56, while monitoring measurement values of laser interferometer 54 W, such that the center of opening 82a of wavefront-aberration measuring unit 80 almost coincides with the imaging point where an image of a given pinhole on the pinhole reticle is formed. At the same time, main controller 50 finely moves Z-tilt stage 58 in the Z-direction via wafer-stage driving portion 56 based on the detection result of the focus detection system (60a, 60b) such that the upper surface of cover glass 88 of wavefront-aberration measuring unit 80 coincides with the image plane on which the pinhole images are formed, as well as adjusting the tilt angle of wafer stage WST as needed. By this, the light beam from the given pinhole are made incident through the center opening of cover glass 88 on light-receiving optical system 84 and received by the light-receiving device of light-receiving portion 86.

The operation will be described in more detail below. A spherical wave is produced from the given pinhole on the pinhole reticle. The spherical wave is made incident on projection optical system PL and passes through light-receiving optical system 84 of wavefront-aberration measuring unit 80, i.e., objective lens 84a, relay lens 84b, mirror 84c and collimator lens 84d which produces parallel rays of the light that illuminate microlens array 84e. By this, the pupil plane of projection optical system PL is relayed to and divided by microlens array 84e. Each lens element of microlens array 84e focuses respective light on the receiving surface of the light-receiving device to form a pinhole image on the receiving surface.

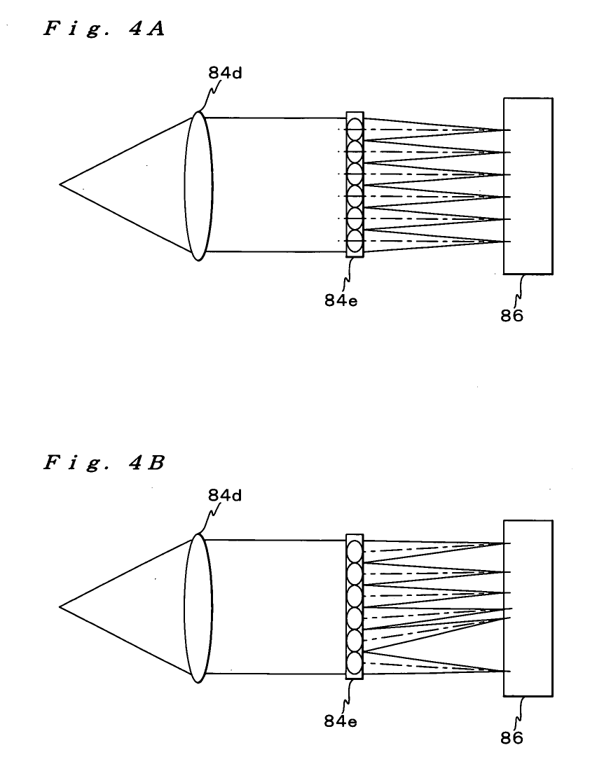

If projection optical system PL is an ideal optical system that does not cause the wavefront-aberration, the wavefront takes an ideal shape (herein, a flat plane) on the pupil plane of projection optical system PL, and thus the parallel rays of the light incident on microlens array 84e come to form a plane wave with an ideal wavefront, in which case a respective spot image (hereinafter, also called a “spot”) is, as shown in FIG. 4A, formed on the optical axis of each lens element of microlens array 84e.

However, because projection optical system PL usually causes wavefront aberration, the wavefront formed by the parallel rays of the light incident on microlens array 84e deviates from the ideal wavefront, and according to the deviation, that is, the tilt angle of the wavefront to the ideal wavefront, the imaging point of each spot deviates from the optical axis of a respective lens element forming part of microlens array 84e as shown in FIG. 4B. In this case, the deviation of each spot from the respective reference point (a position of each lens element on the optical axis) corresponds to the tilt angle of the wavefront.

And the light-receiving device forming part of light-receiving portion 86 converts light (beam for the spot image) incident and focused on each focus point thereon into an electric signal, which is sent to main controller 50 via an electric circuit. Main controller 50 calculates the imaging position of each spot based on the electric signal, and then a position deviation amount (Δξ, Δη) based on the calculation result and known position data of the respective reference points, and stores the position deviation amount (Δξ, Δη) in the RAM, during which main controller 50 receives a corresponding measurement value (Xᵢ, Yᵢ) from laser interferometer 54W.

After wavefront-aberration measuring unit 80 has measured the position deviations of the spot images for the imaging point of the given pinhole, main controller 50 moves wafer stage WST such that the center of opening 82a of wavefront-aberration measuring unit 80 almost coincides with the imaging point of a next pinhole. After that, in the same way as described above, main controller 50 makes light source 16 generate laser beam LB and calculates the imaging position of each spot. For the imaging points of the other pinholes the same measurement sequence is repeated. It is remarked that in the above measurement, the position, size, etc., of the illumination area on the reticle may be changed for each given pinhole by using reticle blind 30 such that only the given pinhole or some pinholes including the given pinhole are illuminated with illumination light EL.

After the completion of all the necessary measurements, the RAM of main controller 50 stores the position deviations (Δξ, Δη) of the spot images for the imaging point of each pinhole and the coordinate data of the imaging point (the corresponding measurement value (Xᵢ, Yᵢ) measured by laser interferometer 54W upon measurement for the imaging point of the pinhole).

Next, main controller 50 loads the first program into the main memory and computes, according to the principle described below, the wavefront (wavefront aberration) for the imaging points of the pinholes, i.e. the first through n^{th} measurement points within the field of projection optical system PL, specifically, the coefficients of the Zernike polynomial given by an equation (4) shown below, e.g. the second term's coefficient Z₂ through the 37^{th} term's coefficient Z₃₇, based on the position deviations (Δξ, Δη) of the spot images for the imaging point of each pinhole and the coordinate data of the imaging point in the RAM by using the first program.

In this embodiment, the wavefront of light having passed through projection optical system PL is obtained based on the position deviations (Δξ, Δη) by using the first program. The position deviations (Δξ, Δη) directly reflect the tilts of the wavefront to the ideal wavefront to the degree that the wavefront is drawn based on the position deviations (Δξ, Δη). It is remarked that, as is obvious from the physical relation between the position deviations (Δξ, Δη) and the wavefront, the principle in this embodiment for calculating the wavefront is the known Shack-Hartmann principle.

Next, the method of calculating the wavefront based on the above position deviations will be described briefly.

As described above, integrating the position deviations (Δξ, Δη), which correspond to the tilts of the wavefront, gives the shape of the wavefront (strictly speaking, deviations from a reference plane (the ideal plane)). Let W(x, y) indicate the wavefront (deviations from the reference plane) and k be a proportional coefficient, then the following equations (2), (3) exist.

$$\begin{matrix}Δξ = k \frac{\partial W}{\partial x} & ( 2 ) \\ Δη = k \frac{\partial W}{\partial y} & ( 3 )\end{matrix}$$

Because it is not appropriate to directly integrate the tilts of the wavefront obtained only in the spot positions, the shape of the wavefront is fitted by and expanded in a series whose terms are orthogonal. The Zernike polynomial is a series suitable to expand a surface symmetrical around an axis in, where its component tangent to a circle is expanded in a trigonometric series. That is, the wavefront W is expanded in the equation (4) when using a polar coordinate system (ρ, θ).

$$W ( ρ , θ ) = {\sum }_{i} {Z}_{i} \cdot {f}_{i} ( ρ , θ ) \qquad ( 4 )$$

Because the terms are orthogonal, coefficients Zᵢ of the terms can be determined independently. The “i” may terminate at a certain number with an effect of a sort of filtering. The first through 37^{th} terms (Zᵢ×fᵢ) are shown in Table 1 as examples. Although the 37^{th} term in Table 1 is, in practice, the 49^{th} term of the Zernike polynomial, in this embodiment it is treated as the 37^{th} term. That is, in the present invention, there is no limit to the number of the terms of the Zernike polynomial.

TABLE 1

| Zᵢ | fᵢ |
|---|---|
| Z₁ | 1 |
| Z₂ | ρ cos θ |
| Z₃ | ρ sin θ |
| Z₄ | 2ρ² − 1 |
| Z₅ | ρ² cos 2θ |
| Z₆ | ρ² sin 2θ |
| Z₇ | (3ρ³ − 2ρ) cos θ |
| Z₈ | (3ρ³ − 2ρ) sin θ |
| Z₉ | 6ρ⁴ − 6ρ² + 1 |
| Z₁₀ | ρ³ cos 3θ |
| Z₁₁ | ρ³ sin 3θ |
| Z₁₂ | (4ρ⁴ − 3ρ²) cos 2θ |
| Z₁₃ | (4ρ⁴ − 3ρ²) sin 2θ |
| Z₁₄ | (10ρ⁵ − 12ρ³ + 3ρ) cos θ |
| Z₁₅ | (10ρ⁵ − 12ρ³ + 3ρ) sin θ |
| Z₁₆ | 20ρ⁶ − 30ρ⁴ + 12ρ² − 1 |
| Z₁₇ | ρ⁴ cos 4θ |
| Z₁₈ | ρ⁴ sin 4θ |
| Z₁₉ | (5ρ⁵ − 4ρ³) cos 3θ |
| Z₂₀ | (5ρ⁵ − 4ρ³) sin 3θ |
| Z₂₁ | (15ρ⁶ − 20ρ⁴ + 6ρ²) cos 2θ |
| Z₂₂ | (15ρ⁶ − 20ρ⁴ + 6ρ²) sin 2θ |
| Z₂₃ | (35ρ⁷ − 60ρ⁵ + 30ρ³ − 4ρ) cos θ |
| Z₂₄ | (35ρ⁷ − 60ρ⁵ + 30ρ³ − 4ρ) sin θ |
| Z₂₅ | 70ρ⁸ − 140ρ⁶ + 90ρ⁴ − 20ρ² + 1 |
| Z₂₆ | ρ⁵ cos 5θ |
| Z₂₇ | ρ⁵ sin 5θ |
| Z₂₈ | (6ρ⁶ − 5ρ⁴) cos 4θ |
| Z₂₉ | (6ρ⁶ − 5ρ⁴) sin 4θ |
| Z₃₀ | (21ρ⁷ − 30ρ⁵ + 10ρ³) cos 3θ |
| Z₃₁ | (21ρ⁷ − 30ρ⁵ + 10ρ³) sin 3θ |
| Z₃₂ | (56ρ⁸ − 105ρ⁶ + 60ρ⁴ − 10ρ²) cos 2θ |
| Z₃₃ | (56ρ⁸ − 105ρ⁶ + 60ρ⁴ − 10ρ²) sin 2θ |
| Z₃₄ | (126ρ⁹ − 280ρ⁷ + 210ρ⁵ − 60ρ³ + 5ρ) cos θ |
| Z₃₅ | (126ρ⁹ − 280ρ⁷ + 210ρ⁵ − 60ρ³ + 5ρ) sin θ |
| Z₃₆ | 252ρ¹⁰ − 630ρ⁸ + 560ρ⁶ − 210ρ⁴ + 30ρ² − 1 |
| Z₃₇ | 924ρ¹² − 2772ρ¹⁰ + 3150ρ⁸ − 1680ρ⁶ + 420ρ⁴ − 42ρ² + 1 |

Because the position deviations detected are the differentials of the wavefront, fitting the differential coefficients for the terms to the position deviations is performed in practice. When expressed in a polar coordinate system (x=ρcos θ, y=ρsin θ), the equations (5), (6) exist.

$$\begin{matrix}\frac{\partial W}{\partial x} = \frac{\partial W}{\partial ρ} cos θ - \frac{1}{ρ} \frac{\partial W}{\partial θ} sin θ & ( 5 ) \\ \frac{\partial W}{\partial y} = \frac{\partial W}{\partial ρ} sin θ + \frac{1}{ρ} \frac{\partial W}{\partial θ} cos θ & ( 6 )\end{matrix}$$

Because the differentials of the terms of the Zernike polynomial are not orthogonal, the least-squares method is used in the fitting. Because the information (position deviation) of each spot image is expressed in two coordinates X and Y, let n indicate the number of the pinholes (e.g. n=about 81 to 400), then the number of sets of equations given by the equations (2) through (6) is 2 n (=about 162 to 800).

Each term of the Zernike polynomial corresponds to an optical aberration. Lower-order terms (i's value being small) almost correspond to Seidel's aberrations. Therefore, the wavefront aberration due to projection optical system PL can be expressed by the Zernike polynomial.

The computation procedure of the first program is determined according to the above principle, and executing the first program gives the wavefront information (wavefront aberration) for the first through n^{th} measurement points within the field of projection optical system PL, specifically, the coefficients of terms of the Zernike polynomial, e.g. the second term's coefficient Z₂ through the 37^{th} term's coefficient Z₃₇.

In the description below, the wavefront data (wavefront aberration) for the first through n^{th} measurement points is expressed by column matrix Q given by the equation (7).

$$Q = [ \begin{matrix}{P}_{1} \\ {P}_{2} \\ ⋮ \\ \\ ⋮ \\ {P}_{n}\end{matrix} ] \qquad ( 7 )$$

In the equation (7), each of the elements P₁ through Pₙ of matrix Q indicates a column matrix (vector) made up of the second through the 37^{th} terms' coefficients (Z₂ to Z₃₇) of the Zernike polynomial.

Main controller 50 stores the wavefront data (e.g. the second term's coefficient Z₂ through the 37^{th} term's coefficient Z₃₇ of the Zernike polynomial) obtained in the above manner in storage unit 42.

Moreover, main controller 50, according to an inquiry from first communication server 120, reads out the wavefront data from storage unit 42 and sends it to first communication server 120 via LAN 118.

Referring back to FIG. 1, stored in the hard disk or the like of first communication server 120 are information related to targets to be achieved in first through third exposure apparatuses 122₁ through 122₃, for example, resolution, effective minimum line width (device rule), the wavelength of illumination light EL (center wavelength and wavelength width in spectrum), information related to patterns to be transferred, and other information related to the projection optical system determining the capabilities of the exposure apparatuses 122₁ through 122₃, which information contains some target values as well as information related to targets to be achieved by exposure apparatuses scheduled to be introduced, e.g., information related to patterns to be transferred.

Meanwhile, the hard disk or the like of second communication server 130 stores an adjustment-amount computing program (hereinafter, called a “second program” for the sake of convenience) for computing an adjustment amount for the imaging characteristic based on the coefficients of terms of the Zernike polynomial, an optimum-exposure-conditions setting program (hereinafter, called a “third program” for the sake of convenience) for setting optimum exposure conditions, and a database associated with the second program.

Next, the database will be described. The database contains numerical data of parameters to calculate target drive amounts (target adjustment amounts) of movable lens elements 13₁, 13₂, 13₃, 13₄ (hereinafter, called “movable lenses”) for adjusting the imaging characteristic of the projection optical system according to the input of measurement result of the optical properties of the projection optical system, in this case, the wavefront aberration. This database is composed of a group of data in which variation amounts of the imaging characteristics are arranged according to a predetermined rule. The variation amounts are obtained as results of simulation, which uses a model substantially equivalent to projection optical system PL and is run with respect to the imaging characteristic corresponding to each of a plurality of measurement points within the field of projection optical system PL, specifically, data of the wavefront aberration, for example, data regarding how the coefficients in the second through 37^{th} terms of the Zernike polynomial vary, in the case when driving movable lenses 13₁, 13₂, 13₃, 13₄ by a unit adjustment quantity in directions of each degree of freedom (drivable directions).

Next, the procedure of generating the database will be briefly described. Exposure conditions, i.e., design values of projection optical system PL (numerical aperture N.A., data of lenses, etc.) and illumination condition (coherence factor σ, the wavelength λ of the illumination light, the shape of the secondary illuminant, etc.) and then, data of a first measurement point within the field of projection optical system PL are inputted into a computer for the simulation where a specific program for calculating the optical properties is installed.

Next, data on unit quantity of the movable lenses in directions of each degree of freedom (movable directions) is input. However, before the input, conditions that are a prerequisite for the input will be described below.

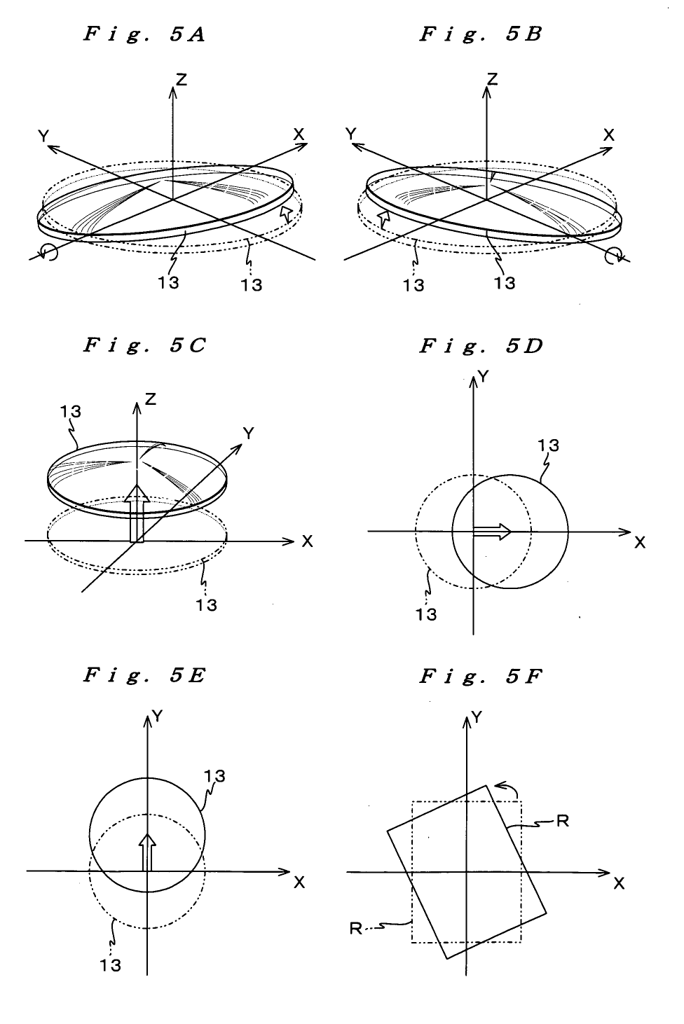

More particularly, for movable lenses 13₁, 13₂, and 13₄, directions in which each of movable lenses 13 are rotated around the X-axis and Y-axis are to be the positive directions of a Y-direction tilt and an X-direction tilt, as is shown by the arrows in FIGS. 5A and 5B, and the unit tilt amount is to be 0.1 degrees. In addition, when each of movable lenses 13 are shifted in the +Z direction as is shown in FIG. SC, the +Z direction is to be the positive direction of the Z-direction shift, and the unit shift amount is to be 100 μm.

In addition, for movable lens 13₃, when it is shifted in the +X direction as is shown in FIGS. 5D and 5E, this direction is to be the + (positive) direction of the X-direction shift, whereas when it is shifted in the +Y direction, this direction is to be the + (positive) direction of the Y-direction shift, and the unit shift amount is to be 100 μm.

And, for example, when instructions to tilt movable lens 13₁ in the + direction of the Y-direction tilt by the unit quantity is input, the simulation computer calculates data of variations of a first wavefront from an ideal wavefront at a first measurement point set in advance within the field of projection optical system PL; for example, variations of the terms' coefficients (e.g. the second term through the 37^{th} term) of the Zernike polynomial. The data of the variations is displayed on the screen of the simulation computer, while also being stored in memory as parameter PARA1P1.

Next, according to instructions to tilt movable lens 13₁ in the + direction of the X direction tilt by a unit quantity, the simulation computer calculates data of a second wavefront at the first measurement point, for example variations of the terms' coefficients of the Zernike polynomial, and displays the data of the variations on the screen thereof while storing them as parameter PARA2P1 in memory.

Next, according to instructions to shift movable lens 13₁ in the + direction of the Z direction shift by a unit quantity, the simulation computer calculates data of a third wavefront at the first measurement point, for example variations of the terms' coefficients of the Zernike polynomial, and displays the data of the variations on the screen thereof while storing them as parameter PARA3P1 in memory.

In the same procedure as described above, for each of the second through n^{th} measurement points, the simulation computer, after data of the measurement point being inputted, calculates data of first, second and third wavefronts, for example variations of the terms' coefficients of the Zernike polynomial, according to instructions to tilt movable lens 13₁ in the Y direction, to tilt in the X direction and to shift in the Z direction respectively and displays data of each variation amount on the screen thereof while storing them as parameters PARA1P2, PARA2P2, PARA3P2, through PARA1Pn, PARA2Pn, PARA3Pn in memory.

Also for other movable lenses 13₂, 13₃, 13₄, in the same procedure as described above, for each of the first through n^{th} measurement points, the simulation computer, after data of the measurement point being inputted, calculates data of wavefronts, for example variations of the terms' coefficients of the Zernike polynomial, according to instructions to drive movable lens 13₂, 13₃, 13₄ in directions of each degree of freedom by a unit quantity and stores the data of wavefronts as parameters (PARA4P1, PARA5P1, PARA6P1, through PARAmP1), (PARA4P2, PARA5P2, PARA6P2, through PARAmP2) through (PARA4Pn, PARA5Pn, PARA6Pn, through PARAmPn) in memory. And a matrix O given by the following expression (8) and composed of column matrices (vectors) PARA1P1 through PARAmPn each of which consists of variations of the terms' coefficients of the Zernike polynomial stored in memory in the above manner is stored as the database in the hard disk or the like of second communication server 130. In this embodiment, because there are three three-degree-of-freedom movable lenses and a two-degree-of-freedom movable lens, m=3×3+2×1=11. The matrix O may be calculated for each exposure apparatus, i.e. projection optical system, or one matrix may be for the same kind (same design values) of projection optical systems.

$$O = [ \begin{matrix}PARA 1 P 1 & PARA 2 P 1 & ⋯ & & ⋯ & PARAmP 1 \\ PARA 1 P 2 & PARA 2 P 2 & ⋯ & & ⋯ & PARAmP 2 \\ ⋮ & ⋮ & & & & ⋮ \\ & & & & & \\ ⋮ & ⋮ & & & & ⋮ \\ PARA 1 Pn & PARA 2 Pn & ⋯ & & ⋯ & PARAmPn\end{matrix} ] \qquad ( 8 )$$

Next, the method in this embodiment of adjusting projection optical system PL of first through third exposure apparatuses 122₁ through 122₃ will be described. In the below, an exposure apparatus 122 indicates any of the exposure apparatuses 122₁ through 122₃ unless there is a need for distinguishing these.

As a premise, upon periodic maintenance, etc., of exposure apparatus 122, according to instructions of a service engineer or the like to measure, main controller 50 of exposure apparatus 122 has measured the wavefront aberration due to projection optical system PL by wavefront-aberration measuring unit 80 and has stored the measured wavefront data in storage unit 42.

First, first communication server 120 inquires at predetermined intervals whether or not there is measurement data of a new wavefront (e.g. the second term's coefficient Z₂ through the 37^{th} term's coefficient Z₃₇ of the Zernike polynomial for the first through n^{th} measurement points), that is, the column matrix Q in the equation (7) described earlier in storage unit 42 of exposure apparatus 122.

At this point of time, suppose that measurement data of a new wavefront is stored in storage unit 42 of exposure apparatus 122 (in practice, any of exposure apparatuses 122₁ through 122₃). Main controller 50 of exposure apparatus 122 sends the measurement data of the new wavefront to first communication server 120 via LAN 118.

First communication server 120 sends the measurement data of the wavefront together with instructions to automatically adjust projection optical system PL (or to compute an adjustment amount of projection optical system PL) to second communication server 130. This data passes through LAN 118, first proxy server 124, and public telephone line 116 and reaches second proxy server 128, which identifies the destination address attached to the data, so that it recognizes the data being sent to second communication server 130 and which sends it to second communication server 130 via LAN 126.

Second communication server 130 receives the data and displays its notification together with the identifier of the source of the data on screen while storing the measurement data of the wavefront in a hard disk or the like, and calculates an adjustment amount of projection optical system PL, i.e. adjustment amounts of movable lenses 13₁ through 13₄ in directions of each degree of freedom, in the following manner.

Second communication server 130 loads the second program into the main memory from the hard disk or the like and computes the adjustment amounts of movable lenses 13₁ through 13₄ in directions of each degree of freedom, which computation is specifically shown in the below.

Between data Q of the wavefront (wavefront aberration) for the first through n^{th} measurement points, the matrix O contained in the database, and an adjustment-amounts vector P of movable lenses 13₁ through 13₄ in directions of each degree of freedom, there exists the equation (9)
Q=O·P (9)

In the equation (9), P indicates a column matrix (vector) having m elements given by the equation (10).

$$P = [ \begin{matrix}ADJ 1 \\ ADJ 2 \\ ⋮ \\ \\ ⋮ \\ ADJm\end{matrix} ] \qquad ( 10 )$$

Therefore, computing the following equation (11) obtained from the equation (9) with using the least-squares method gives P's elements ADJ1 through ADJm, that is, adjustment amounts (target adjustment amounts) of movable lenses 13₁ through 13₄ in directions of each degree of freedom. In this case, since there are a plurality of movable lenses and the movable lenses each have a plurality of degrees of freedom, sometimes zero adjustment amount may be calculated as the “target adjustment amount” related to at least one direction of degree of freedom of a certain movable lens. In this specification, a term of “target adjustment amount” is used including such a concept.
P=(O^{T}·O)⁻¹·O^{T}·Q (11)

In the equation (11), O^{T} and (O^{T}·O)⁻¹ indicates the transposed matrix of matrix O and the inverse matrix of (O^{T}·O) respectively.

That is, the second program is a program for performing a least-squares-method computation given by the equation (11) using the database. Therefore, second communication server 130 calculates the adjustment amounts ADJ1 through ADJm according to the second program while reading the database from the hard disk into RAM.

Next, second communication server 130 sends the adjustment amounts ADJ1 through ADJm to main controller 50 of exposure apparatus 122. By this operation, data containing the adjustment amounts ADJ1 through ADJm passes through LAN 126, second proxy server 128, and public telephone line 116 and reaches first proxy server 124, which identifies the destination address attached to the data, so that it recognizes the data being sent to exposure apparatus 122 and which sends it to exposure apparatus 122 via LAN 118. In practice, when the address attached to the data containing the adjustment amounts ADJ1 through ADJm is AD2, AD3, or AD4, the data is sent to exposure apparatus 122₁, 122₂ or 122₃ respectively.

Second communication server 130 can send first communication server 120 the data containing the calculated adjustment amounts ADJ1 through ADJm, in which case first communication server 120 relays the data to main controller 50 of exposure apparatus 122 that sent the corresponding wavefront data before.

In either case, main controller 50 of exposure apparatus 122 that received the data containing the calculated adjustment amounts ADJ1 through ADJm gives imaging-characteristic correcting controller 48 instruction values to drive movable lenses 13₁ through 13₄ in directions of each degree of freedom corresponding to the adjustment amounts ADJ1 through ADJm. Imaging-characteristic correcting controller 48 controls the voltages applied to devices for driving movable lenses 13₁ through 13₄ in directions of degree of freedom, so that at least one of the position and posture of each of movable lenses 13₁ through 13₄ is adjusted and the imaging characteristic of projection optical system PL, i.e. aberrations such as distortion, field curvature, coma, spherical aberration, and astigmatism, is corrected. It is remarked that as to coma, spherical aberration and astigmatism, higher orders of aberration components can be corrected as well as lower orders of aberration components.

As is obvious in the above description, movable lenses 13₁ through 13₄, the devices for driving these movable lenses, imaging-characteristic correcting controller 48 and main controller 50 compose an imaging-characteristic adjusting mechanism that functions as an adjusting unit in this embodiment.

It is remarked that first communication server 120 may send the data containing the adjustment amounts ADJ1 through ADJm to imaging-characteristic correcting controller 48 via main controller 50 of exposure apparatus 122 that sent the corresponding wavefront data before so as to adjust at least one of the position and posture of each of movable lenses 13₁ through 13₄.

In this embodiment as described above, after a service engineer or the like attaches wavefront-aberration measuring unit 80 to Z-tilt stage 58, the imaging characteristic of projection optical system PL, according to instructions to measure the wavefront aberration that are inputted via input unit 45, is accurately adjusted almost automatically and in a remote-controlled manner.

While in the above description the projection optical system is automatically adjusted, the aberrations may include an aberration difficult to automatically be corrected. In this case, a skilled engineer on second communication server 130's side gets corresponding wavefront measurement data in the hard disk of second communication server 130 displayed on screen and analyzes it to find out a problem, and, if an aberration difficult to automatically be corrected is included, inputs an appropriate measure through the key-board or the like of second communication server 130 and remotely gets it displayed on the screen of display unit 44 of exposure apparatus 122. A service engineer or the like on the maker A's side can adjust the projection optical system by finely adjusting the positions, etc., of lenses based on the appropriate measure on the screen in a short time.

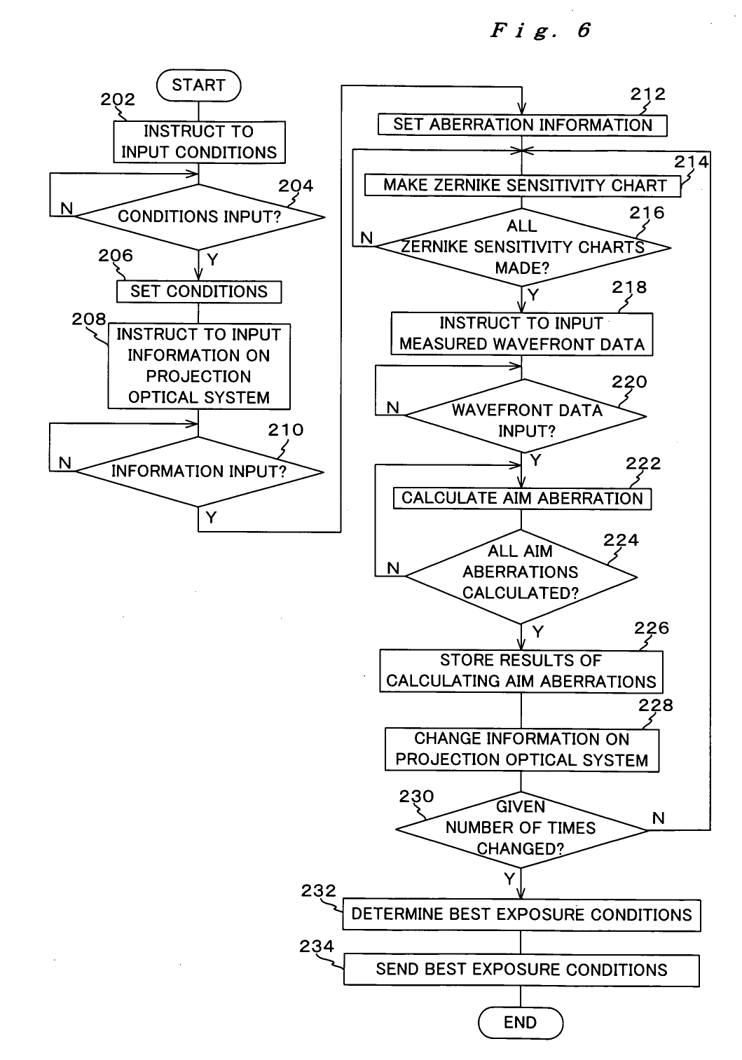

Next, the procedure of setting the optimum exposure conditions of exposure apparatus 122 (122₁ through 122₃) will be described with reference to a flowchart of FIG. 6 showing main part of a process algorithm to be executed by the CPU of second communication server 130. As a premise, upon periodic maintenance, etc., of exposure apparatus 122, according to service engineer's instructions to measure, for example, main controller 50 of first exposure apparatus 122₁ has already measured the wavefront aberration due to projection optical system PL by wavefront-aberration measuring unit 80 and has stored the measured wavefront data in the hard disk or the like of first communication server 120 in the same way as above. It is noted that although also in setting the optimum exposure conditions data communication between first communication server 120 or exposure apparatus 122₁ and second communication server 130 is performed likewise, explanation concerning communication and communication paths will be omitted for the sake of simplicity.

The process in the flowchart of FIG. 6 starts when according to instructions of an operator on the maker A's side first communication server 120, with specifying an exposure apparatus whose optimum exposure conditions are to be determined, has instructed second communication server 130 to determine the optimum exposure conditions and second communication server 130, in response to this, has loaded the third program into the main memory. The process beginning with a step 202 in FIG. 6 is performed by executing the third program.

First, in the step 202 second communication server 130 instructs to input of conditions to first communication server 120, and then in a step 204 second communication server 130 waits for the conditions being inputted.

During this, according to instructions of the operator to determine the optimum exposure conditions, first communication server 120 inquires of, e.g., a host computer (not shown) managing the exposure apparatuses 122₁ through 122₃ the information of a reticle to be used this time by exposure apparatus 122₁ and, based on the information of the reticle, searches for and gets pattern information thereof from a predetermined database. Moreover, first communication server 120 has inquired of main controller 50 of exposure apparatus 122₁ current-setting information such as an illumination condition and has stored it in memory.

Alternatively the operator may manually input the pattern information and information such as an illumination condition via an input unit into first communication server 120.

In either case, first communication server 120 inputs the pattern information for the simulation (e.g., in the case of a line-and-space pattern, line widths, pitch, duty ratio, etc., or the design data of an actual pattern) together with information of a specified aim imaging characteristic (including an index value of the imaging characteristic; the aim imaging characteristic being called an “aim aberration” hereinafter) and information of a line-width abnormal value and so forth.

When first communication server 120 has completed the input of the conditions, the process proceeds to a step 206 in FIG. 6, which sets conditions for making a Zernike Sensitivity chart of the aim aberration inputted in the step 204, and then proceeds to a step 208. It is remarked that the aim aberration information inputted in the step 204 may specify plural kinds of aberrations in projection optical system PL as aim aberrations (imaging characteristic) at the same time, not being limited to a single one.

In the step 208, it instructs first communication server 120 to input information related to projection optical system PL of exposure apparatus 122₁, and then in a step 210 second communication server 130 waits for the input. And when the information related to projection optical system PL, specifically a numerical aperture N.A., an illumination condition (such as setting of the illumination-system aperture stop or coherence factor σ), a wavelength, etc., has been inputted, in a step 212 second communication server 130 stores the inputted information in RAM and sets specified aberration information. As an example, the second term's coefficient Z₂ through the 37^{th} term's coefficient Z₃₇ of the Zernike polynomial are set such that each term takes on, for example, a value 0.05λ.

A next step 214 makes graphs (e.g. a Zernike Sensitivity chart (a calculating table) of a line-width abnormal value) whose ordinate is information of aberration that is set based on the input pattern information and the information related to projection optical system PL, for example, an aim aberration corresponding to 0.05λ or its index value (for example, the line-width abnormal value that is an index value of coma) and whose abscissas correspond to terms' coefficients of the Zernike polynomial, and the process proceeds to a step 216.

Here, the Zernike Sensitivity chart is a table data that is composed of sensitivities (Zernike Sensitivity), to a specific aberration when the input pattern is a subject pattern, i.e. the aim aberration (or its index), of coefficients of terms of the Zernike polynomial in which the wavefront in the projection optical system is expanded. Here, “sensitivities (Zernike Sensitivity) of coefficients of terms of a Zernike polynomial” means the imaging capability of the projection optical system under predetermined exposure conditions, for example, variation amounts per 1λ in each term of the Zernike polynomial corresponding to various aberrations (or their index values). Herein, the term that sensitivity (Zernike Sensitivity) of coefficients in terms of a Zernike polynomial is used to denote such meaning.

The Zernike Sensitivity chart is uniquely defined based on the pattern information and the information related to projection optical system PL that are input, and the set aberration information as well as, for the same kind of projection optical systems, based on design information containing the kind and configuration of lens elements composing the projection optical system. Therefore, by searching in the in-house database of the maker B for and identifying the kind of the projection optical system of an exposure apparatus specified based on designation (e.g. designation of product name) of the exposure apparatus whose optimum exposure conditions are to be determined, the Zernike Sensitivity chart corresponding to the aim aberration can be made.

A next step 216 checks whether or not Zernike Sensitivity charts for all the aim aberrations specified in the step 204 have been made. If the judgment is negative, the process returns to the step 214, and a Zernike Sensitivity chart for a next aim aberration is made.

After Zernike Sensitivity charts for all the aim aberrations have been made, and the affirmative judgment is made in the step 216, the process proceeds to a next step 218. In the step 218, it instructs first communication server 120 to input measurement data of the wavefront, then in a step 220 second communication server 130 waits for the input of the measurement data. When first communication server 120 has inputted from its hard disk the measurement data of the wavefront (for example, the second term's coefficient Z₂ through the 37^{th} term's coefficient Z₃₇ of the Zernike polynomial for wavefront for the first through n^{th} measurement points), in a next step 222 second communication server 130 performs, for each measurement point, computation given by the following equation (12) using the Zernike Sensitivity charts (calculating tables) that have been made in order to obtain and store one of the aim aberrations, specified in the step 204, in RAM.
A=K·{Z₂·(a Sensitivity chart's value)+Z₃·(a Sensitivity chart's value)+ . . . +Z₃₇·(a Sensitivity chart's value)} (12)

Here, A indicates an aim aberration in projection optical system PL such as astigmatism or field curvature, or an index of the aim aberration such as a line-width abnormal value that is an index of coma, and K is a proportional constant depending on the sensitivity of the resist and so forth.

When A indicates the line-width abnormal value, and the pattern is a line-and-space pattern having five lines therein for example, the line-width abnormal value is given by the above equation (1). As is obvious in the equation (1), the calculation of the equation (12) is the one for converting the pattern into aerial images (projected images).

A next step 224 checks whether or not all the aim aberrations (aberrations (imaging characteristic) for which conditions were set) have been calculated. If the judgment is negative, the process returns to the step 222, and a next aim aberration is calculated and stored in RAM.

When all the aim aberrations have been calculated, in a step 226 the calculation results of all the aim aberrations in RAM are stored in the hard disk or the like, and the process proceeds to a next step 228.

In the step 228, after the information related to projection optical system PL, specifically a numerical aperture N.A., an illumination condition (such as setting of the illumination-system aperture stop or coherence factor σ), a wavelength, etc., has been changed partly compared to the one given in the step 210, in a step 230 second communication server 130 checks whether or not the information has been changed a predetermined number of times. At this point of time, because the information related to projection optical system PL has been changed only once, the judgment is negative, and after the process returns to the step 214, the process of the steps 214 through 230 is repeated, in the step 214 of which a Zernike Sensitivity chart is made based on the information related to projection optical system PL that has been changed in the step 228. In this manner, the process of the steps 214 through 230 is repeated each time with partly different illumination condition, numerical aperture, wavelength, etc. After the process has been repeated the predetermined number of times, the affirmative judgment is made in the step 230, and the process proceeds to a next step 232. At this point of time, the calculation results of the aim aberrations for the predetermined number of conditions settings are stored in the hard disk or the like.

In the step 232, second communication server 130 determines conditions (an illumination condition, a numerical aperture, a wavelength, etc.) concerning the projection optical system, under which the aim aberrations stored in the hard disk or the like take on optimum values (for example, zero or minimum), as optimum exposure conditions.

In a next step 234, data containing the optimum exposure conditions are sent to first communication server 120, and the process of this routine ends.

First communication server 120, which has received the data containing the optimum exposure conditions, instructs, as needed, main controller 50 of exposure apparatus 122₁ to set its exposure conditions to the optimum exposure conditions. Specifically, main controller 50 can change and set the illumination condition by changing the aperture stop of illumination-system aperture stop plate 24, or can adjust the numerical aperture of projection optical system PL by adjusting pupil aperture stop 15 of projection optical system PL shown in FIG. 2. Alternatively, main controller 50 can set the wavelength of exposure light by giving light source 16 control information TS to change the wavelength of illumination light EL.

It is noted that second communication server 130 may directly instruct exposure apparatus 122₁ to set its exposure conditions to the optimum exposure conditions.

Moreover, by making a slight modification to the third program whose process is shown by the flowchart in FIG. 6, while gradually changing the pattern information with the setting information other than the pattern information fixed, the process of making Zernike Sensitivity charts and calculating aim aberrations (or aerial images) based on the measurement data of the wavefront is repeatedly performed. By this operation, it is also possible to determine the setting information of the optimum pattern, as optimum exposure conditions.

Likewise, by making a slight modification to the third program whose process is shown by the flowchart in FIG. 6, while changing information on the aberration to be given with the setting information other than the information on the aberration to be given fixed, the process of making Zernike Sensitivity charts and calculating aim aberrations (or aerial images) based on the measurement data of the wavefront is repeatedly performed. By this operation, it is also possible to determine the aberration to be given to the projection optical system when transferring the input pattern, as optimum exposure conditions. In this case, second communication server 130 adjusts the imaging characteristic by controlling imaging-characteristic correcting controller 48 via main controller 50 of exposure apparatus 122₁ so that such an aberration (for example, the second term's coefficient Z₂ through the 37^{th} term's coefficient Z₃₇ of the Zernike polynomial) is given to projection optical system PL. Alternatively second communication server 130 may adjust the imaging characteristic by controlling imaging-characteristic correcting controller 48 via first communication server 120 and main controller 50 so that such an aberration is given to projection optical system PL.

Optimum exposure conditions of the exposure apparatuses 122₂, 122₃ are set in the same way as described above.

In this embodiment, upon periodic maintenance, etc., of exposure apparatus 122, when a service engineer or the like inputs condition settings, information related to the projection optical system, etc., through first communication server 120, second communication server 130 makes Zernike Sensitivity charts using another program partly different from the third program in the same way as the simulation for setting optimum exposure conditions. And, according to instructions of the service engineer or the like, main controller 50 of exposure apparatus 122 measures the wavefront aberration and sends position deviation data obtained from the measurement via first communication server 120 to second communication server 130, which calculates the aim aberration in the same way as described above. Second communication server 130 calculates drive amounts of movable lenses 13₁ through 13₄ in directions of each degree of freedom which amounts make the aim aberration optimal (e.g. zero or minimal), by using the another program and the least-squares method. And second communication server 130 supplies instruction values of the drive amounts to imaging-characteristic correcting controller 48 via main controller 50, according to which imaging-characteristic correcting controller 48 controls voltages applied to the devices for driving movable lenses 13₁ through 13₄ in directions of degrees of freedom, so that at least one of the position and posture of each of movable lenses 13₁ through 13₄ is adjusted and that the aim aberration of projection optical system PL such as distortion, field curvature, coma, spherical aberration, astigmatism, etc., is corrected. It is remarked that as to coma, spherical aberration and astigmatism, higher orders of aberration components can be corrected as well as lower orders of aberration components. In this case the second program is not necessarily used.

Moreover, in this embodiment when the another program partly different from the third program is installed in storage unit 42 from drive unit 46, automatic adjustment of the imaging characteristic of projection optical system PL by exposure apparatus 122 itself upon adjustment of projection optical system PL of exposure apparatus 122 such as periodic maintenance is easily achieved. In this case, according to instructions of an operator (with condition settings, information related to the projection optical system, etc., inputted), the CPU of main controller 50 performs the same process in the same way as in the above simulation, to make the same Zernike Sensitivity charts. And after position deviation data obtained by measuring the wavefront aberration has been inputted, the CPU of main controller 50 calculates the aim aberration in the same way as described above and then drive amounts of movable lenses 13₁ through 13₄ in directions of each degree of freedom which amounts make the aim aberration optimal (e.g. zero or minimal), by using the another program and the least-squares method. And the CPU of main controller 50 supplies instruction values of the calculated drive amounts to imaging-characteristic correcting controller 48, according to which imaging-characteristic correcting controller 48 controls voltages applied to the devices for driving movable lenses 13₁ through 13₄ in directions of each degree of freedom, so that at least one of the position and posture of each of movable lenses 13₁ through 13₄ is adjusted and the aim aberration of projection optical system PL such as distortion, field curvature, coma, spherical aberration, astigmatism, etc., is corrected. It is remarked that as to coma, spherical aberration and astigmatism, higher orders of components can be corrected as well as lower orders of components.

As is obvious in the above description, movable lenses 13₁ through 13₄, in the embodiment, the devices for driving these movable lenses, and imaging-characteristic correcting controller 48 compose an imaging-characteristic adjusting mechanism which functions as an adjusting unit, and main controller 50 composes a controller which controls the imaging-characteristic adjusting mechanism.

It is noted that while wavefront-aberration measuring unit 80 measures the wavefront aberration due to projection optical system PL in the above description, not being limited to this, the wavefront aberration may be measured by using a measurement reticle R_{T} described below (hereinafter, also called a “reticle R_{T}” as needed)

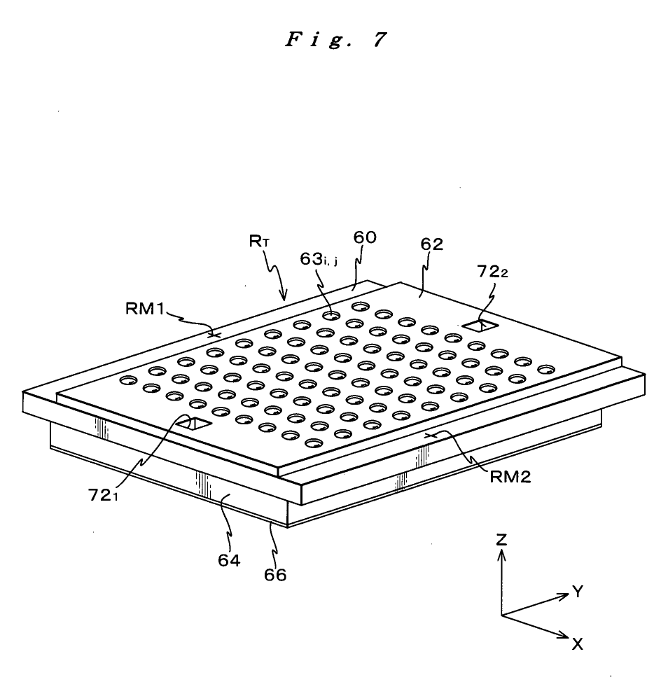

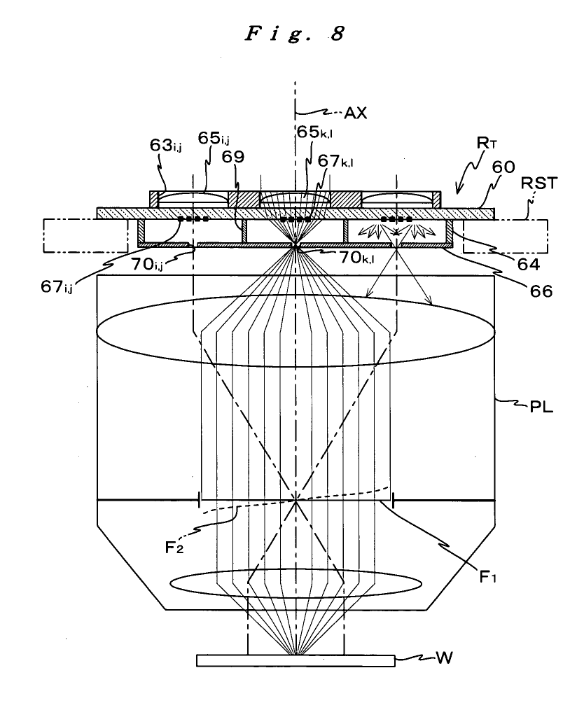

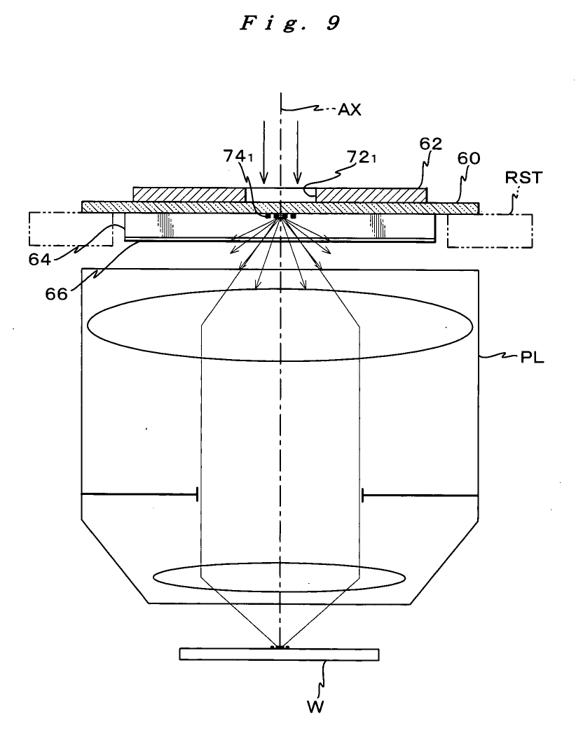

FIG. 7 shows a schematic oblique view of measurement reticle R_{T}, and FIG. 8 shows a schematic view of the cross section of reticle R_{T} along a X-Z plane near the optical axis AX and a diagram of projection optical system PL. FIG. 9 shows a schematic view of the cross section of reticle R_{T} along a X-Z plane near the end in the −Y side and a diagram of projection optical system PL.

As is obvious in FIG. 7, measurement reticle R_{T} has almost the same shape as a usual reticle with a pellicle and comprises a glass substrate 60, a lens-holding member 62 having a rectangular-plate-like shape and which is fixed on the upper surface of glass substrate 60 in FIG. 7 such that its center coincides with that of glass substrate 60, a spacer member 64 constituted by a frame member fixed on the bottom surface of glass substrate 60 in FIG. 2 and having the same shape as a usual pellicle frame, and an aperture plate 66 fixed on the bottom surface of spacer member 64.

In lens-holding member 62, a matrix arrangement of n circular apertures 63_{i,j} (i=1 through p, j=1 through q, p×q=n) is formed which covers the other part of the surface than both the ends in the Y-direction. Provided inside of circular apertures 63_{i,j} are condenser lenses 65_{i,j} each constituted by a convex lens whose optical axis is parallel to the Z-direction (refer to FIG. 8).

Inside the space enclosed by glass substrate 60, spacer member 64 and aperture plate 66, supporting members 69 are arranged spaced a predetermined distance apart from each other as shown in FIG. 8.

Furthermore, measurement patterns 67_{i,j} are formed on the opposite side of glass substrate 60 to condenser lenses 65_{i,j} as shown in FIG. 8. Made opposite measurement patterns 67_{i,j} in aperture plate 66 as shown in FIG. 8 are pinhole-like openings 70_{i,j}, whose diameter is, for example, about 100 to 150 μm.

Referring back to FIG. 7, openings 72₁, 72₂ are made in center of the band areas in the ends in the Y-direction of lens-holding member 62 respectively. A reference pattern 74₁ is formed opposite opening 72₁ on the bottom surface (pattern surface) of glass substrate 60 as shown in FIG. 9. Although not shown, a reference pattern (referred to as a ‘reference pattern 74₂’ for the sake of convenience) identical to reference pattern 74₁ is formed opposite other opening 72₂ on the bottom surface (pattern surface) of glass substrate 60.

Moreover, as shown in FIG. 7, a pair of reticle alignment marks RM1, RM2 is formed symmetrically with respect to the reticle's center, on the center line parallel to the X-direction of glass substrate 60 and outside lens-holding member 62.

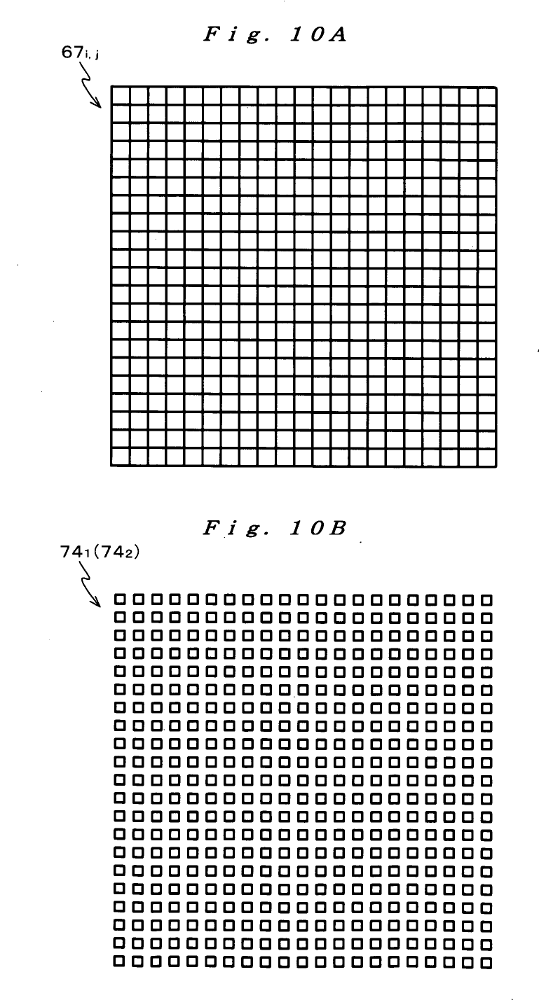

Here, in this embodiment, measurement patterns 67_{i,j} are a mesh (street-lines-like) pattern as shown in FIG. 10A. Corresponding to these, reference patterns 74₁, 74₂ are two-dimensional patterns with square features arranged at the same pitch as measurement pattern 67_{i,j} as shown in FIG. 10B. It is remarked that reference pattern 74₁, 74₂ may be the pattern of FIG. 10A while the measurement pattern is the pattern of FIG. 10B. Furthermore, measurement pattern 67_{i,j} may be a pattern having a different shape, in which case the corresponding reference pattern needs to be a pattern having a predetermined positional relation with the measurement pattern. That is, the reference pattern only has to be a pattern providing the reference for position deviation of the measurement pattern. Whatever the shape thereof is, the pattern preferably covers the whole image field or exposure area of projection optical system PL in order to measure the imaging characteristic (the optical properties) of projection optical system PL.

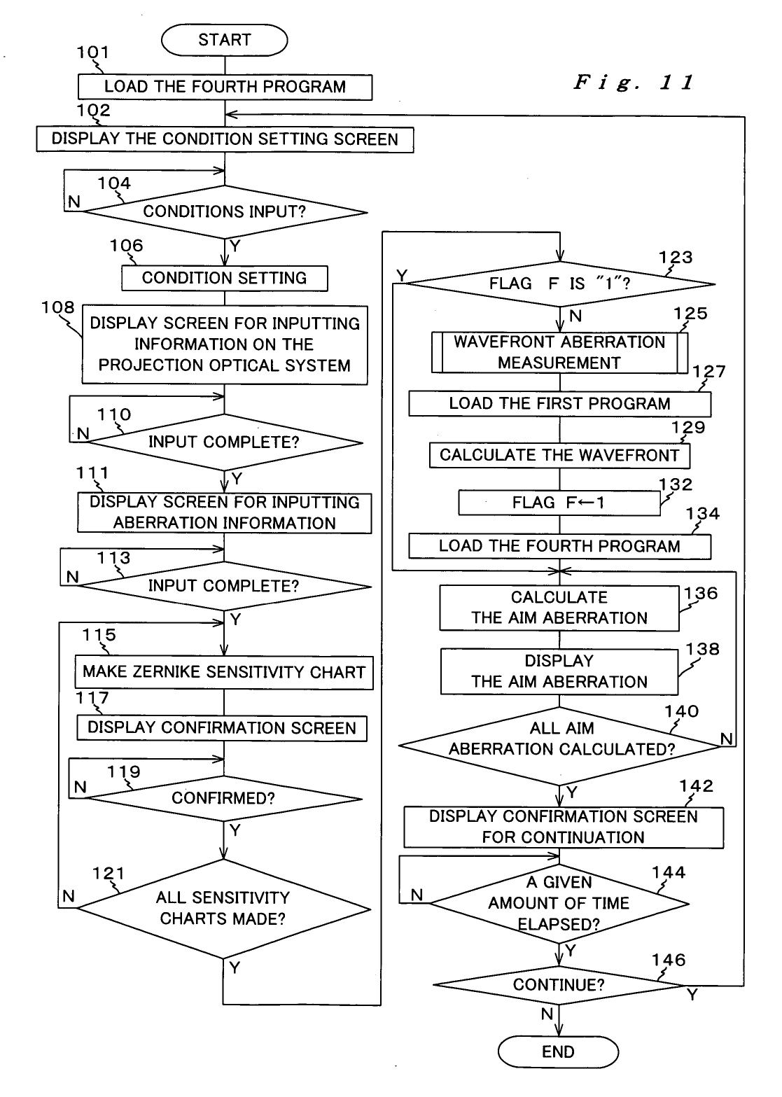

Next, the method of measuring and displaying (simulating) imaging characteristics will be described so that an operator of exposure apparatus 122 (exposure apparatuses 122₁ to 122₃) can easily understand the state of aberrations of projection optical system PL, following a flowchart in FIG. 11, which schematically shows the control algorithm of the CPU in main controller 50, and referring to other figures when necessary.

As a premise, the CD-ROM containing the first, second and fourth programs and the database is set in drive unit 46, and from the CD-ROM, the first and fourth programs are to be installed in storage unit 42. In this case, the fourth program is a program that converts coefficients of terms of the Zernike polynomial into various imaging characteristics (including index values of the imaging characteristics).

The process in the flowchart starts when the operator inputs the instructions to start the simulation via input unit 45.

First, in step 101, the fourth program is loaded into the main memory. Then, steps 102 through 121 are executed, according to the fourth program.

First, in step 102, when the screen for setting conditions is displayed on display unit 44, the process then goes to step 104 and waits for the conditions to be input. The operator then inputs information on a pattern subject to simulation (for example, in the case of a line-and-space pattern, the pitch, the line width, and duty ratio or the like) and information on an aim imaging characteristic (including an index value of the imaging characteristic; the aim imaging characteristic also hereinafter referred to as “aim aberration” as appropriate) such as information on a line width abnormal value, via input unit 45. Then, when instructions are given that the input is complete, the process proceeds to step 106, where conditions are set for making a Zernike Sensitivity chart of the aim aberration input in step 104, and the step then proceeds to step 108. The information on aim aberration entered in step 104 is not limited to one kind. That is, various kinds of imaging characteristics of projection optical system PL can be designated as the aim aberration at the same time.

In step 108, when the screen for inputting information on the projection optical system is displayed on display unit 44, the process then goes to step 110 and waits for the information to be input. And after the operator inputs information on projection optical system PL, specifically information on the numerical aperture (N.A.), illumination conditions (such as setting of the illumination system aperture stop or coherence factor σ), wavelength or the like via input unit 45, the process goes to step 111, where the input information is stored in the RAM and when the screen for inputting information on the aberration is displayed on display unit 44, the procedure moves on to step 113 and waits for the information to be input.

The operator then individually inputs information on a given aberration, or to be more specific, individually inputs the same value, such as 0.05 λ, into the input screen for aberration information for the coefficient values of each term of the Zernike polynomial when they are, for example, coefficient Z₂ of the second term up to coefficient Z₃₇ of the 37^{th} term.

When input of the above aberration is complete, the process proceeds to step 115, where a graph is made (for example, a Zernike Sensitivity chart (calculating table) on a line width abnormal value), based on the information of aberration that has been input. For example, the ordinate of the graph can be an aim aberration corresponding to the 0.05λ or its index value (such as the line width abnormal value, which is the index value of coma), and the abscissas can be the coefficients of each term of the Zernike polynomial. The process then proceeds to step 117, where the screen for confirming the completion of the above graph is displayed on display unit 44.

In the next step, step 119, operation is suspended until the operator inputs the confirmation. When the operator inputs the confirmation via input unit 45 such as the mouse, the process then proceeds to step 121, where the sensitivity chart made in the above step 115 is stored in the RAM, and the decision is made whether or not the Zernike Sensitivity charts are made for all the aim aberrations input in step 104. When the decision is negative, the process then returns to step 115 to make a Zernike Sensitivity chart and for the next aim aberration. In the embodiment, one sensitivity chart is made for one aim aberration without changing any conditions such as the numerical aperture of projection optical system PL or the illumination conditions, however, for example, a plurality of sensitivity charts may be made for one aim aberration changing at least either the numerical aperture of projection optical system PL or the illumination conditions. In addition, the pattern subject to simulation may be in plurals, and the sensitivity chart for the target aberration may be made per pattern.

When the sensitivity charts have been made for all the aim aberrations and the confirmation has been input in step 119, the decision turns positive in step 121 and the process proceeds to the next step, step 123.

In step 123, the decision is made whether a flag F is “1” or not. Flag F indicates whether data of positional deviation amounts (Δξ′, Δη′), which will be described later, has been input. In this case, because data of the positional deviation amounts (Δξ′, Δη′) has not been input, the decision is negative, which takes the process to a measuring subroutine 125, where wavefront aberration is measured using measurement reticle R_{T} at a plurality of measurement points (hereinafter, n) in the field of projection optical system PL in the following manner.

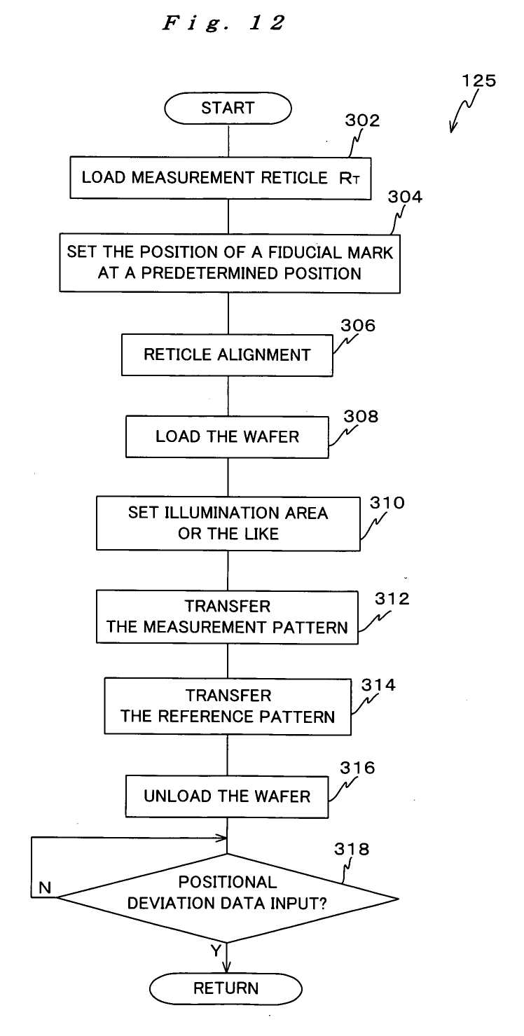

That is, in subroutine 125, first of all, in step 302 in FIG. 12, measurement reticle R_{T} is loaded onto reticle stage RST via a reticle loader (not shown).

In the next step, step 304, wafer stage WST is moved via wafer-stage driving portion 56 while the output of laser interferometer 54W is being monitored, and a pair of reticle alignment fiducial marks formed on fiducial mark plate FM is positioned at a predetermined reference position. The reference position, in this case, is set so that, for example, the center of the pair of fiducial marks coincides with the origin of the stage coordinate system set by laser interferometer 54W.

In step 306, the pair of reticle alignment marks RM1 and RM2 formed on measurement reticle R_{T} and the corresponding reticle alignment fiducial marks are observed with the reticle alignment microscopes at the same time, and reticle stage RST is finely driven in the XY two-dimensional plane via a driving system (not shown) so as to make positional deviations minimal between projected images of reticle alignment marks RM1 and RM2 on reference plate FM and the reticle alignment fiducial marks. With this operation, reticle alignment is completed, and the center of the reticle substantially coincides with the optical axis of projection optical system PL.

In the next step, step 308, wafer W is loaded onto Z-tilt stage 58 via a wafer loader (not shown). The surface of wafer W is coated with a resist (photosensitive agent).

In the next step, step 310, the aperture size of reticle blind 30 is set via a drive system (not shown) so that a rectangular shaped illumination area is formed to cover the entire surface of measurement reticle R_{T} including all condenser lenses 65_{i,j}, with the exception of openings 72₁, 72₂, and the length of the illumination area in the X-axis direction length is within the maximum width of the X-axis direction of lens-holding member 62. In addition, at the same time, illumination-system aperture stop plate 24 is rotated via driving unit 40 to set a predetermined aperture stop, such as the small σ stop, to the optical path of illumination light EL. With this operation, the preparatory operations for exposure are completed.

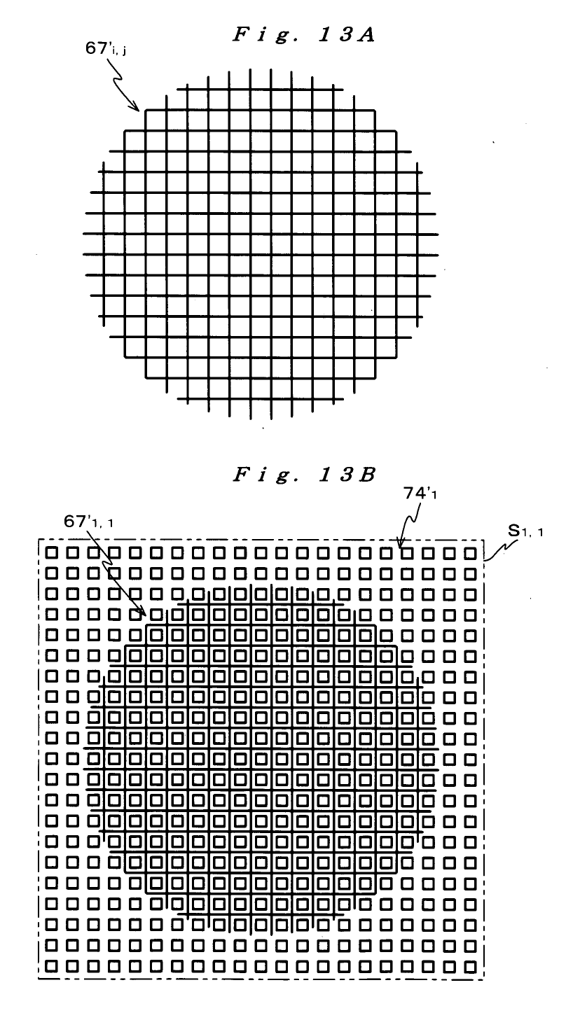

In the next step, step 312, control information TS is given to light source 16 so that laser beam LB is generated, and exposure is performed by irradiating reticle R_{T} with illumination light EL. With this operation, measurement patterns 67_{i,j} are each simultaneously transferred via pinhole-like openings 70_{i,j} and projection optical system PL, as is shown in FIG. 8. As a result, reduced images 67′_{i,j} (latent images) of measurement patterns 67_{i,j} as is shown in FIG. 13A are formed two-dimensionally on the resist layer of wafer W, spaced apart at a predetermined distance.

In the next step, step 314, the reference pattern is sequentially overlaid and transferred onto the images of the measurement patterns already formed on wafer W by a step-and-repeat method. Following are the details of the sequence, from a. through g.
a. First, reticle stage RST is driven in the Y-axis direction by a predetermined distance via a driving system (not shown), so that the center of reference pattern 74₁ coincides with optical axis AX, based on the measurement values of a reticle laser interferometer (not shown) and the designed positional relation between the center of the reticle and reference pattern 74₁.
b. Next, when the above movement is completed, the aperture of reticle blind 30 is set via a driving system (not shown) so that the illumination area of illumination light EL is set limited to a rectangular area having a predetermined size, on lens-holding member 62 including opening 72₁ (but does not include any condenser lenses).
c. Next, wafer stage WST is moved so that the center of the area where a latent image 67′_{1,1} of a first measurement pattern 67_{1,1} is formed on wafer W is positioned substantially on optical axis AX, while the measurement values of laser interferometer 54W are monitored.
d. Then, main controller 50 gives control information TS to light source 16 for generating laser beam LB, and performs exposure by irradiating illumination light EL on reticle R_{T}. With this operation, reference pattern 74₁ is overlaid and transferred onto the area where the latent image of measurement pattern 67_{1,1} is already formed (referred to as area S_{1,1}) on the resist layer of wafer W. As a result, latent image 67′_{1,1} of first measurement pattern 67_{1,1} and the latent image 74′₁ of reference pattern 74₁ are formed on area S_{1,1} in a positional relation shown in FIG. 13B.
e. Next, main controller 50 calculates a designed arrangement pitch p of measurement patterns 67_{i,j} on wafer W, based on an arrangement pitch of measurement patterns 67_{i,j} on reticle R_{T} and the projection magnification of projection optical system PL. Then, main controller 50 moves wafer stage WST in the X-axis direction by pitch p so that the center of an area S_{1,2} where the latent image of the second measurement pattern 67_{1,2} is formed substantially coincides with optical axis AX.
f. Then, main controller 50 gives control information TS to light source 16 so that laser beam LB is emitted and exposure is performed by irradiating illumination light EL on reticle R_{T}. With this operation, reference pattern 74₁ is overlaid and transferred onto area S_{1,2} on wafer W.
g. Hereinafter, stepping operations between areas and exposure operation are repeated in the manner described above, and latent images of the measurement patterns and the reference pattern are formed in areas S_{i,j} on wafer W, as shown is in FIG. 13B.

When exposure is completed in this manner, the process goes to step 316, where wafer W is unloaded from Z-tilt stage 58 via the wafer loader (not shown) and is transferred to a coater-developer (not shown; hereinafter, “C/D” for short), which is connected in line with chamber 11. The process then proceeds to step 318, where data of positional deviation amounts (Δξ′, Δη′), which will be described later, will be input.

Then, in the C/D, wafer W is developed, and the resist images of the measurement pattern and the reference pattern are formed on wafer W in the same arrangement as shown in FIG. 13B, in each of areas S arranged in a matrix.

Then, wafer W that has been developed is removed from the C/D, and overlay errors are measured in each of areas S_{i,j} by an external overlay measuring unit (registration measuring unit). And, based on the results, positional errors (positional deviation amounts) of the resist images of measurement patterns 67_{i,j} with respect to the corresponding images of reference pattern 74₁ are calculated.

Various methods of calculating the positional deviation amounts can be considered, however, from the viewpoint of improving accuracy, performing statistical computation based on measured raw data is preferred.

In this manner, the XY two-dimensional positional deviation amounts (Δξ′, Δη′) of the measurement patterns from the respective reference patterns are obtained for areas S_{i,j}. Then the data on positional deviation amounts (Δξ′, Δη′) for areas S_{i,j} is input by an operator (or the service engineer described earlier or the like) via input unit 45. And, when the decision in step 318 is positive, the process then returns to step 127 in the main routine of FIG. 11.

Incidentally, data on positional deviation amounts (Δξ′, Δη′) in areas S_{i,j} can be input online from the external overlay measuring unit. And, also in this case, the process returns to step 127 in the main routine responding to the input.

In step 127 in the main routine, the first program (a conversion program that converts positional deviation amounts (Δξ′, Δη′) (measured using measurement reticle R_{T}) into coefficients of terms of the Zernike polynomial) is loaded into the main memory, and then the process goes to the next step, step 129. In step 129, based on the positional deviation amounts (Δξ′, Δη′) that has been input, wavefronts (wavefront aberrations) corresponding to each of areas S_{i,j}, or in other words, the first measurement point through the n^{th} measurement point within the field of projection optical system PL, which in this case are the coefficients of each of the terms in the Zernike polynomial such as the coefficient Z₂ of the second term through the coefficient Z₃₇ of the 37^{th} term, are calculated according to the first program. When the main memory has enough empty area, the fourth program, which is loaded in advance, can be stored in the main memory, however, in this case the main memory does not have enough empty area, therefore, the fourth program is temporarily unloaded from the main memory to its original area in storage unit 42, and then the first program is loaded in the main memory.

In the embodiment, the wavefront of projection optical system PL is obtained by calculation according to the first program, based on the above positional deviation amounts (Δξ′, Δη′). The physical relation between the positional deviation amounts (Δξ′, Δη′) and the wavefront, which is the premise of the calculation, will be briefly described, referring to FIGS. 8 and 9.

As represented by a measurement pattern 67_{k,l} in FIG. 8, one of sub-beams diffracted by a measurement pattern 67_{i,j} passes through a respective pinhole-like opening 70_{i,j} and then the pupil plane of projection optical system PL in a different position depending on the position of measurement pattern 67_{i,j}. That is, wavefront's part in each position on the pupil plane mainly reflects the wavefront of the sub-beam from the corresponding measurement pattern 67_{i,j}. If projection optical system PL caused no aberration, the wavefront on the pupil plane of projection optical system PL would become an ideal one (herein, a flat plane) indicated by a numerical reference F₁. However, because projection optical systems that cause no aberration do not exist, the wavefront on the pupil plane becomes a curved surface F₂ represented by a dotted curve for example. Therefore, measurement pattern 67_{i,j} is imaged in a position on wafer W that deviates according to the angle that the curved surface F₂ makes with the ideal wavefront.

Meanwhile, light diffracted by reference pattern 74₁ (or 74₂), as shown in FIG. 9, is not restricted by a pinhole-like aperture, is made incident directly on projection optical system PL and is imaged on wafer W through projection optical system PL. Moreover, because exposure of reference pattern 74₁ is performed in a state where the center of reference pattern 74₁ is positioned on the optical axis of projection optical system PL, almost no aberration of the imaging beam from reference pattern 74₁ is caused by projection optical system PL, so that the image is formed with no position deviation on a small area that the optical axis passes through.

Therefore, the position deviation amounts (Δξ′, Δη′) directly reflect the tilts of the wavefront to an ideal wavefront, and conversely the wavefront can be reproduced based on the position deviation amounts (Δξ′, Δη′). It is noted that as physical relation between the position deviation amounts (Δξ′, Δη′) and the wavefront indicates, the principle in the embodiment for calculating the wavefront is the known Shack-Hartmann wavefront calculation principle.

Disclosed in U.S. Pat. No. 5,978,085 is an invention concerning the technology where a plurality of measurement patterns on a mask having the same structure as measurement reticle R_{T} are sequentially imaged on a substrate through respective pinholes and a projection optical system, where a reference pattern on the mask is imaged on the substrate through the projection optical system but not through condenser lenses and the pinholes, and where position deviations of the resist images of the plurality of measurement patterns from the respective resist images of the reference pattern are measured to calculate the wavefront aberration by a predetermined computation.

In the above step 129, by the computation according to the first program, the wavefront (wavefront aberration) corresponding to the first up to the n^{th} measurement point within the field of projection optical system PL, or in this case, the coefficients of terms of the Zernike polynomial, such as the coefficient Z₂ of the second term up to the coefficient Z₃₇ of the 37^{th} term, can be obtained.

After the data of the wavefront (the coefficients of terms of the Zernike polynomial, such as the coefficient Z₂ of the second term through the coefficient Z₃₇ of the 37^{th} term) is obtained, the process proceeds to step 132, which sets the flag F to one and stores the data of the wavefront in a temporary storage area in the RAM.

In step 134, the fourth program is reloaded into the main memory. In this case, as a matter of course, the fourth program is loaded after the first program is unloaded into the original area in storage unit 42.

In the next step, step 136, according to the fourth program, one of the aim aberrations input in step 104 is calculated for each measurement point by the equation (12) described previously, using the Zernike Sensitivity chart (calculating table) made earlier.

In the next step 138, the aim aberration or its index value calculated for each measurement point in the manner above is shown on display unit 44. And, by this display, the operator can easily recognize the aberration of projection optical system PL in question.

In the next step, step 140, the decision is made whether or not all the aim aberrations (aberrations (imaging characteristics) for which conditions have been set) have been calculated. If the decision is negative, the process returns to step 136, and the next aim aberration is calculated and displayed.

When all the aim aberrations have been calculated in the manner above, the process proceeds to step 142 where a screen for verifying whether the simulation is to continue is displayed on display unit 44, and then the process proceeds to step 144 and stays there until a predetermined time has passed.

When the predetermined time has passed, the step moves to step 146, where decision is made on whether or not instructions to continue the simulation has been input. When the simulation is to be continued, instructions for continuance should be given during the predetermined time, therefore, if the answer in step 146 is negative, the process of this routine ends based on the decision that the simulation does not have to continue.

Meanwhile, when instructions to continue the simulation have been input during the predetermined time, the process returns to step 102, and hereinafter repeatedly performs the process and decision-making, according to the next conditions specified in the simulation. However, in this case, because the flag F is set, the decision in step 123 is positive so the process goes from step 123 to step 136.

That is, when the wavefront aberration of projection optical system PL has been measured once, the simulation is continued without re-measuring the wave-front aberration.

As is described above, in the embodiment, the operator only has to sequentially input necessary items via input unit 45 according to the screen, as well as input instructions to measure the wavefront aberration, or in addition, also input data of the positional deviation amounts (Δξ′, Δη′) in each of areas S_{i,j} measured by the overlay measuring unit. And, with this operation, because the aim aberration specific to the object pattern of projection optical system PL (including lower-order and higher-order components of coma, astigmatism, and spherical aberration) is automatically and accurately calculated and displayed on display unit 44, the aberration can be easily and accurately recognized. Furthermore, even when the aim aberrations are in plurals, the aberration can be accurately recognized, by measuring the wavefront aberration of projection optical system PL only once. In this case, while there are various forms for displaying the aim aberration, the form is preferred where the results are expressed numerically in a way that is easy for anyone to understand. In such a case, analysis of the coefficients of terms of the Zernike polynomial or the like is not required.

Moreover, as is obvious from the flowchart in FIG. 11, the exposure apparatus in the embodiment can easily set the optimum exposure condition corresponding to the subject patterns. That is, the optimum exposure condition can be easily set when repeating the steps 102 and onward, by inputting the same subject pattern and the same aim aberration (which may be a plurality of types) to the condition setting screen in step 102, and by sequentially inputting different illumination conditions, numerical apertures, wavelengths, and the like to the input screen in step 108 where information related to projection optical system PL is input. As a consequence, in step 138, the condition is defined in which the target aberration value shown in step 138 is minimal. Needless to say, the software can be modified so that main controller 50 automatically defines and sets the optimum exposure condition based on the definition. This is because, for example, the illumination condition can be changed respectively by selecting a different aperture stop of illumination-system aperture stop plate 24, the numerical aperture of projection optical system PL can be set freely within a certain range by adjusting pupil aperture stop 15 in FIG. 2 of projection optical system PL, and the wavelength of illumination light EL can be changed by giving such control information TS to light source 16.

Needless to say, information on the defined exposure condition may be used when the operator creates a process program file (data file for setting exposure conditions).

Incidentally, the input of the measurement instructions of the wavefront aberration by an operator (including a service engineer) via input unit 45 can also make the exposure apparatus execute the wavefront aberration measurement of projection optical system PL using measurement reticle R_{T} described earlier.

Further, in the above step 125, the wavefront aberration (the positional deviation amount (Δξ′, Δη′)) of projection optical system PL may be measured using wavefront-aberration measuring unit 80.

Next, the method of adjusting the imaging characteristic of projection optical system PL will be described which is performed by a service engineer of the exposure apparatus maker or the like, in a semiconductor manufacturing factory.

As a premise, the CD-ROM containing the first, second and fourth programs and the database created in the manner above is set in drive unit 46, and the first, second and fourth programs are installed in storage unit 42, along with the database associated with the second program.

When instructions for measuring the wavefront aberration is input by the service engineer or the like, main controller 50 (CPU) transfers the pattern of measurement reticle R_{T} onto wafer W for measuring the wavefront aberration at a plurality of (in this case, n) measurement points in the field of projection optical system PL in the same procedure as is previously described (refer to FIG. 12). Wafer W is then developed in the C/D, and when wafer W has been developed, the resist images of the measurement pattern and the reference pattern are formed in each of areas S_{i,j} arranged in a matrix on wafer W, in the same arrangement as is shown in FIG. 13B.

After that, wafer W that has been developed is removed from the C/D, and overlay errors are measured with an external overlay measuring unit (registration measuring unit) in areas S_{i,j}. And, based on the results, position errors (positional deviation amounts) of the resist images of measurement patterns 67_{i,j} from the corresponding images of reference pattern 74₁ are calculated. Incidentally, main controller 50 may measure the wavefront aberration of projection optical system PL using wavefront-aberration measuring unit 80, in response to the instructions to measure the wavefront aberration.

Then, the data on the positional deviation amounts (Δξ′, Δη′) (or (Δξ, Δη)) in areas S_{i,j} is input into main controller 50 by the service engineer or the like via input unit 45 (or from wavefront-aberration measuring unit 80). Incidentally, the data on the positional deviations (Δξ, Δη) in areas S_{i,j} may be input into main controller 50 online from the external overlay measuring unit.

In any case, responding to the above input, the CPU of main controller 50 loads the first program in the main memory, and based on the positional deviation amounts (Δξ′, Δη′) (or (Δξ, Δη)), the wavefront (wavefront aberration) for areas S_{i,j} corresponding to the first through n^{th} measurement point within the field of projection optical system PL, in this case, the coefficients for each of the terms in the Zernike polynomial, such as the coefficient Z₂ of the second term up to the coefficient Z₃₇ of the 37^{th} term of the Zernike polynomial are computed, that is, matrix Q in the equation (7) described earlier is computed, according to the first program.

When matrix Q is calculated in the manner above, the CPU in main controller 50 then stores the values in the temporary storing area in the RAM.

Next, the CPU in main controller 50 loads the second program into the main memory from storage unit 42, and computes the adjustment amount of movable lenses 13₁ through 13₄ previously described in directions of each degree of freedom, according to the second program. More specifically, the CPU performs the following computation.

Between data Q of the wavefront (wavefront aberration) for the first to n^{th} measurement points, the matrix O stored in the CD-ROM as the database, and an adjustment amounts vector P of movable lenses 13₁ through 13₄ in directions of each degree of freedom, a relation as in the equation (9) described earlier exists.

Therefore, from the above equation (9), by computing the equation (11) described earlier using the least-squares method, each of the elements ADJ1 to ADJm of P, or in other words, adjustment amount (target adjustment amount) of movable lenses 13₁ through 13₄ in directions of each degree of freedom can be obtained.

The CPU calculates the adjustment amount ADJ1 to ADJm according to the second program while sequentially reading the database from the CD-ROM into the RAM, and then shows the adjustment amounts on the screen of display unit 44 as well as stores the values in storage unit 42.

Next, main controller 50 gives instruction values to imaging-characteristic correcting controller 48 according to the adjustment amounts ADJ1 through ADJm stored in storage unit 42 on the drive amounts of movable lenses 13₁ through 13₄ in directions of each degree of freedom. With this operation, imaging-characteristic correcting controller 48 controls the applied voltage to each of the driving devices that drives movable lenses 13₁ through 13₄ in directions of each degree of freedom, and at least one of the position and posture of movable lenses 13₁ through 13₄ is adjusted substantially at the same time, correcting the imaging characteristic of projection optical system PL such as distortion, field curvature, coma, spherical aberration, and astigmatism. As for coma, spherical aberration and astigmatism, not only the lower orders but also the higher orders of the aberration can be corrected.

As is described above, in the embodiment, when adjusting the imaging characteristic of projection optical system PL, the service engineer or the like only has to input measurement instructions of the wavefront aberration via input unit 45, or in addition, input the positional deviation amounts (Δξ′, Δη′) for areas Sᵢⱼ measured by the overlay measuring unit. With this operation, the imaging characteristic of projection optical system PL is adjusted almost automatically, with high accuracy.

Instead of the equation (11) described previously, the following equation, equation (13), which is a computation program for performing a least-squares computation, may be used as the second program.
P=(O^{T}·G·O)⁻¹·O^{T}·G·Q. (13)

In equation (13), G is a diagonal matrix with n rows and n columns as in the following equation, equation

$$( 14 ) \text{:} \\ G = [ \begin{matrix}{A}_{1 , 1} & & & & & \\ & {A}_{2 , 2} & & & 0 & \\ & & . & & & \\ & & & . & & \\ & 0 & & & . & \\ & & & & & {A}_{n . n}\end{matrix} ] \qquad ( 14 )$$

In addition, elements A_{i,i} (i=1 through n) of matrix G each are a diagonal matrix with weight parameters δ as the elements. In this case, A_{i,i} is a diagonal matrix with 36 rows and 36 columns expressed as in equation (15):

$${A}_{i , i} = [ \begin{matrix}{δ}_{1 , 1} & & & & & \\ & {δ}_{2 , 2} & & & 0 & \\ & & . & & & \\ & & & . & & \\ & 0 & & & . & \\ & & & & & {δ}_{36 , 36}\end{matrix} ] \qquad ( 15 )$$

Therefore, each of elements δ_{j,j} (j=1 through 36) of diagonal matrix A_{i,i} represents the weight parameter corresponding to the coefficients Z₂ through Z₃₇ of the second term to the 37^{th} term of the Zernike polynomial for the wavefront aberration measured at each measurement point. So, for example, when lower-order distortion obtained from the measurement results of one or a plurality of measurement points is to be corrected in particular, the values of the weight parameters such as δ_{1,1} and δ_{2,2} at the corresponding measurement points only have to be made heavier than the rest of the weight parameters. In addition, for example, when spherical aberration (0θ component) obtained from the measurement results of one or a plurality of measurement points is to be corrected in particular including the higher-order component, the mean of weight parameters δ_{8,8}, δ_{15,15}, δ_{24,24}, δ_{35,35}, δ_{36,36} at the corresponding measurement points only has to be made heavier than the mean of the remaining weight parameters.

In this case, another program that works with the second program is preferably provided, and the screens for specifying a measurement point and inputting the weight for each of the terms of the Zernike polynomial are to be sequentially displayed by the program. With such an arrangement, the service engineer or the like can easily set the weight parameters described above using input unit 45, by inputting the measurement point when the screen for specifying the measurement point is displayed and by inputting the weight of the term of the Zernike polynomial corresponding to the aberration to be corrected in particular heavier than the other terms when the screen for inputting the weight is displayed. Especially, on the input screen for inputting the weight, a plurality of types of input referred to above are preferred, more specifically, other than being able to input the weight of each term, input of the weight divided into four groups such as 0θ, 1θ, 3θ, and 4θ is preferred. In the latter case, a desired set value can be input by each θ group. 0θ generically refers to coefficients of the terms of the Zernike polynomial (in this case, the first and fourth terms are excluded) that do not include sin or cos (Z₉, Z₁₆, Z₂₅, Z₃₆, and Z₃₇) ; 1θ generically refers to coefficients of terms (in this case, the second and third terms are excluded) with sin θ or cos θ (Z₇, Z₈, Z₁₄, Z₁₅, Z₂₃, Z₂₄, Z₃₄, and Z₃₅) ; 2θ generically refers to coefficients of terms with sin 2θ or cos 2θ (Z₅, Z₆, Z₁₂, Z₁₃, Z₂₁, Z₂₂, Z₃₂, and Z₃₃); 3θ generically refers to coefficients of terms with sin 3θ or cos 3θ (Z₁₉l, Z₂₀, Z₃₀, and Z₃₁), and 4θ generically refers to coefficients of terms with sin 4θ or cos 4θ (Z₂₈ and Z₂₉).

In the embodiment, as is previously described, main controller 50 executes the fourth program and the first program so that the imaging characteristic (aberration) of projection optical system PL to be known can be recognized almost automatically, when the operator or the like sequentially inputs necessary issues via input unit 45 according to the display on the screen and inputs instructions to measure the wavefront aberration, or in addition, inputs the data on positional deviation amounts (Δξ′, Δη′) for areas S_{i,j} measured by the overlay measuring unit. Therefore, after the imaging characteristic of projection optical system PL is adjusted in the manner previously described by making use of such arrangement, the service engineer or the like performs the simulation previously described so that the state of whether the imaging characteristic is adjusted as planned can be confirmed on the display screen. When the adjustment is not proceeding as planned, by inputting a plurality of imaging characteristics as information related to the aim imaging characteristic, the imaging characteristic that is not adjusted as planned can be recognized, therefore, necessary countermeasures can be taken without further delay.

In this embodiment, other than the maintenance operation, the operator or the like may also give instructions to adjust the imaging characteristic of projection optical system PL even during normal operation, as needed. After the operator or the like gives the predetermined instructions described earlier (including input of condition setting and input of information related to the projection optical system), a process similar to the above simulation is performed in the same manner by the CPU of main controller 50 to make a similar Zernike Sensitivity chart. Then, when the wavefront aberration is measured and the positional deviation data input, the CPU of main controller 50 sequentially calculates the aim imaging characteristic in the manner described above. In this case, instead of displaying information related to the aim imaging characteristic on display unit 44, or with the display, the CPU may calculate the drive amount of movable lenses 13₁ to 13₄ in directions of each degree of freedom so that the aim aberration is optimal (such as zero or minimal) according to, for example, the second program by the least-squares method in the same manner as before. This can be achieved by a simple modification of the software.

Then, the CPU in main controller 50 provides the instruction values of the calculated drive amount to imaging-characteristic correcting controller 48. With this operation, imaging-characteristic correcting controller 48 controls the applied voltage to each of the driving devices that drives movable lenses 13₁ through 13₄ in directions of each degree of freedom, and at least one of the position and posture of movable lenses 13₁ through 13₄ is adjusted, correcting the imaging characteristic of projection optical system PL such as distortion, field curvature, coma, spherical aberration, and astigmatism. As for coma, spherical aberration and astigmatism, not only the lower orders but also the higher orders of the aberration can be corrected.

Incidentally, when semiconductor devices are manufactured using the exposure apparatuses 122₁ through 122₃ in the embodiment, preparation such as reticle alignment, so-called baseline measurement and EGA (Enhanced Global Alignment) is performed after a reticle R for manufacturing the devices is loaded onto reticle stage RST.

The above preparation such as reticle alignment and baseline measurement is disclosed in detail in, for example, Kokai (Japanese Unexamined Patent Application Publication) No. 4-324923 and U.S. Pat. No. 5,243,195 corresponding thereto. Furthermore, the EGA is disclosed in detail in, for example, Kokai (Japanese Unexamined Patent Application Publication) No. 61-44429 and U.S. Pat. No. 4,780,617 corresponding thereto. The disclosures in the above U.S. Patents are incorporated herein by reference.

After that, exposure of the step-and-repeat method as in the measurement of the wavefront aberration using measurement reticle R_{T} is performed, in which stepping is performed based on the result of wafer alignment. Because the exposure operation is the same as in a usual stepper, its detailed description is omitted.

Next, the method of making projection optical system PL in the making of exposure apparatus 122 (122₁ through 122₃) will be described.

a. Determining the Specification for Projection Optical System PL

An engineer or the like of the maker A inputs into first communication server 120 via an input unit (not shown) target information that the exposure apparatus to achieve such as an exposure wavelength, a minimum line width (resolution) and information regarding a subject pattern, and instructs first communication server 120, via the input unit, to send the target information.

First communication server 120 inquires of second communication server 130 whether or not it can receive data, and, when second communication server 130 replies that it can receive data, sends the target information to second communication server 130.

Second communication server 130 receives and analyzes the target information, selects one of seven methods described later for determining the specification based on the result of the analysis, and determines and stores the specification in RAM.

Here, before explaining the methods of determining the specification, what aberration (coefficient Zᵢ) the term of the Zernike polynomial (fringe Zernike polynomial) in which the wavefront is expanded is associated with will be briefly described. Each term includes the function fᵢ (ρ,θ) as shown in table 1 and is a term of n^{th} order and mθ, where n indicates the maximum power of ρ and m the coefficient of θ.

The 0 order, 0θ term (coefficient Z₁) represents the position of the wavefront and is not associated with any aberration.

The first order, 1θ term (coefficients Z₂, Z₃) represents the distortion component.

The second order, 0θ term (coefficient Z₄) represents the field curvature.

The third and over order, 0θ terms (coefficients Z₉, Z₁₆, Z₂₅, Z₃₆, Z₃₇) represent the spherical aberration component.

The 2θ terms (coefficients Z₅, Z₆, Z₁₂, Z₁₃, Z₂₁, Z₂₂, Z₃₂, Z₃₃) and the 4θ terms (coefficients Z₁₇, Z₁₈, Z_{28,} Z₂₉) represent the astigmatism component.

The third and over order, 1θ terms (coefficients Z₇, Z₈, Z₁₄, Z₁₅, Z₂₃, Z₂₄, Z₃₄, Z₃₅), the third and over order, 3θ terms (coefficients Z₁₀, Z₁₁, Z₁₉, Z₂₀, Z₃₀, Z₃₁) and the 5θ terms (coefficient Z₂₆, Z₂₇) represent the coma component.

The seven methods of determining the specification with using as a standard the wavefront aberration amount that projection optical system PL is to satisfy will be described in the below.

<A First Method>

In this method, the coefficients of specific terms are selected as standards, based on the target information out of the terms of the Zernike polynomial in which the wavefront in the projection optical system is expanded. In the first method, with using, e.g., the coefficients Z₂, Z₃ corresponding to the distortion component as standards when the target information contains a resolution for example, the specification of projection optical system PL is determined such that the coefficients within the field are equal to or less than respective, predetermined values.

<A Second Method>

In this method, with using the RMS value (Root-Mean-Square value) of the coefficients of the terms of the Zernike polynomial in which the wavefront in the projection optical system is expanded as a standard, the specification of projection optical system PL is determined such that the RMS value within the field does not exceed a predetermined permissible value. By the second method, the aberration that is defined in the entire field such as field curvature can be constrained. The second method can be suitably applied to any target information. Alternatively, for each coefficient the RMS value of its values within the field may be used as a standard.

<A Third Method>

In this method, with selecting as standards the coefficients of the terms of the Zernike polynomial in which the wavefront in the projection optical system is expanded, the specification of projection optical system PL is determined such that the coefficients within the field do not exceed permissible values that are individually set. In the third method the permissible values may all be the same values or different from each other, or some of the limits may be the same in value.

<A Fourth Method>

In this method, with using as a standard the RMS value, within the field, of the coefficients of terms (n^{th} order, mθ terms), which correspond to a specific aberration being watched, out of the terms of the Zernike polynomial in which the wavefront in the projection optical system is expanded, the specification of projection optical system PL is determined such that the RMS value does not exceed a predetermined permissible value. In the fourth method, when the target information contains pattern information, the pattern information is analyzed to presume which aberration must particularly be restricted in order to form a good projected image of the pattern on the image plane, and then based on the presumption, the permissible values for the RMS values of the coefficients of n^{th} order, mθ terms are determined, for example, as follows.

Let the RMS value A₁ of the coefficients Z₂, Z₃ within the field be a standard, then the standard A₁≦permissible value B₁.

Let the RMS value A₂ of the coefficient Z₄ within the field be a standard, then the standard A₂≦permissible value B₂.

Let the RMS value A₃ of the coefficients Z₅, Z₆ within the field be a standard, then the standard A₃≦permissible value B₃.

Let the RMS value A₄ of the coefficients Z₇, Z₈ within the field be a standard, then the standard A₄≦permissible value B₄.

Let the RMS value As of the coefficient Z₉ within the field be a standard, then the standard A₅≦permissible value B₅.

Let the RMS value A₆ of the coefficients Z₁₀, Z₁₁ within the field be a standard, then the standard A₆≦permissible value B₆.

Let the RMS value A₇ of the coefficients Z₁₂, Z₁₃ within the field be a standard, then the standard A₇≦permissible value B₇.

Let the RMS value A₈ of the coefficients Z₁₄, Z₁₅ within the field be a standard, then the standard A₈≦permissible value B₈.

Let the RMS value A₉ of the coefficient Z₁₆ within the field be a standard, then the standard A₉≦permissible value B₉.

Let the RMS value A₁₀ of the coefficients Z₁₇, Z₁₈ within the field be a standard, then the standard A₁₀≦permissible value B₁₀.

Let the RMS value A₁₁ of the coefficients Z₁₉, Z₂₀ within the field be a standard, then the standard A₁₁≦permissible value B₁₁.

Let the RMS value A₁₂ of the coefficients Z₂₁, Z₂₂ within the field be a standard, then the standard A₁₂≦permissible value B₁₂.

Let the RMS value A₁₃ of the coefficients Z₂₃, Z₂₄ within the field be a standard, then the standard A₁₃≦permissible value B₁₃.

Let the RMS value A₁₄ of the coefficient Z₂₅ within the field be a standard, then the standard A₁₄≦permissible value B₁₄.

Let the RMS value A₁₅ of the coefficients Z₂₆, Z₂₇ within the field be a standard, then the standard A₁₅≦permissible value B₁₅.

Let the RMS value A₁₆ of the coefficients Z₂₈, Z₂₉ within the field be a standard, then the standard A₁₆≦permissible value B₁₆.

Let the RMS value A₁₇ of the coefficients Z₃₀, Z₃₁ within the field be a standard, then the standard A₁₇≦permissible value B₁₇.

Let the RMS value A₁₈ of the coefficients Z₃₂, Z₃₃ within the field be a standard, then the standard A₁₈≦permissible value B₁₈.

Let the RMS value A₁₉ of the coefficients Z₃₄, Z₃₅ within the field be a standard, then the standard A₁₉≦permissible value B₁₉.

Let the RMS value A₂₀ of the coefficients Z₃₆, Z₃₇ within the field be a standard, then the standard A₂₀≦permissible value B₂₀.

<A Fifth Method>

In a fifth method, with using as a standard the RMS value, within the field, of the coefficients of each group of mθ terms having the same mθ value out of terms, which correspond to a specific aberration being watched, out of the terms of the Zernike polynomial in which the wavefront in the projection optical system is expanded, the specification of projection optical system PL is determined such that the RMS value for each group does not exceed each permissible value that is individually set.

For example, let the RMS value C₁, within the field, of the coefficients Z₉, Z₁₆, Z₂₅, Z₃₆, Z₃₇ of the third and over order, 0θ terms be a standard, then the standard C₁≦permissible value D₁.

Let the RMS value C₂, within the field, of the coefficients Z₇, Z₈, Z₁₄, Z₁₅, Z₂₃, Z₂₄, Z₃₄, Z₃₅ of the third and over order, 1θ terms be a standard, then the standard C₂≦permissible value D₂.

Let the RMS value C₃, within the field, of the coefficients Z₅, Z₆, Z₁₂, Z₁₃, Z₂₁, Z₂₂, Z₃₂, Z₃₃ of the 2θ terms be a standard, then the standard C₃≦permissible value D₃.

Let the RMS value C₄, within the field, of the coefficients Z₁₀, Z₁₁, Z₁₉, Z₂₀, Z₃₀, Z₃₁ of the 3θ terms be a standard, then the standard C₄≦permissible value D₄.

Let the RMS value C₅, within the field, of the coefficients Z₁₇, Z₁₈, Z₂₈, Z₂₉ of the 4θ terms be a standard, then the standard C₅≦permissible value D₅.

Let the RMS value C₆, within the field, of the coefficients Z₂₆, Z₂₇ of the 5θ terms be a standard, then the standard C₆≦permissible value D₆.

Also in this method, as is obvious from the meanings of the coefficients, when the target information contains pattern information, the pattern information is analyzed to presume which aberration must particularly be restricted in order to form a good projected image of the pattern on the image plane, a standard is selected based on the presumption.

<A Sixth Method>

In a sixth method, with using a given standard of the RMS value, within the field, of coefficients given by weighting according to the target information the coefficients of the terms of the Zernike polynomial in which the wavefront in the projection optical system is expanded, the specification of the projection optical system is determined such that the RMS value does not exceed a predetermined permissible value. Also in this method when the target information contains pattern information, the pattern information is analyzed to presume which aberration must particularly be restricted in order to form a good projected image of the pattern on the image plane, the weights are determined based on the presumption.

<A Seventh Method>

A seventh method can be employed only when the target information contains information related to a pattern that the projection optical system projects. In the seventh method, based on the pattern information, by running a simulation for obtaining an aerial image formed on the image plane when the projection optical system projects the pattern and analyzing the simulation result, the specification of the projection optical system is determined using as a standard the wavefront aberration amount allowed for the projection optical system such that the pattern is transferred finely. In this case, as a method of the simulation, for example, a Zernike Sensitivity chart similar to the one described above may be made in advance, and an aerial image may be obtained based on a liner combination between sensitivities (Zernike Sensitivity) to a specific aberration (including its index value) obtained from the Zernike Sensitivity chart and the coefficients of terms of the Zernike polynomial in which the wavefront of the projection optical system is expanded. The sensitivities (Zernike Sensitivity) of coefficients of terms of the Zernike polynomial in which the wavefront in the projection optical system is expanded depends on the pattern that is a subject pattern.

More specifically, there exists a relation given by the following equation (16) between a matrix f with n rows and m columns that comprises various aberrations (including their index values) in n measurement points (evaluation points) within the field of the projection optical system, for example, m kinds of aberrations, and a matrix Wa with n rows and 36 columns that comprises wavefront aberration data at the n measurement points, for example, terms' coefficients of the Zernike polynomial in which the wavefront aberration is expanded, for example, the second term's coefficient Z₂ through the 37^{th} term's coefficient Z₃₇, and a matrix ZS with ,e.g., 36 rows and m columns that comprises data of a Zernike Sensitivity chart (i.e. a variation amount (Zernike Sensitivity) per 1λ in coefficients of terms of the Zernike polynomial of m kinds of various aberrations under predetermined exposure conditions, for example, in the second term's coefficient Z₂ through the 37^{th} term's coefficient Z₃₇).
f=Wa·ZS (16)

Here, f, Wa, and ZS are represented by, for example, the equations (17), (18) and (19) respectively.

$$\begin{matrix}f = [ \begin{matrix}{f}_{1 , 1} & {f}_{1 , 2} & ⋯ & {f}_{1 , m} \\ {f}_{2 , 1} & ⋰ & & {f}_{2 , m} \\ ⋮ & & ⋰ & ⋮ \\ {f}_{n , 1} & {f}_{n , 2} & ⋯ & {f}_{n , m}\end{matrix} ] & ( 17 ) \\ Wa = [ \begin{matrix}{Z}_{1 , 2} & {Z}_{1 , 3} & ⋯ & {Z}_{1 , 36} & {Z}_{1 , 37} \\ {Z}_{2 , 2} & & & & {Z}_{2 , 37} \\ ⋮ & & ⋰ & & ⋮ \\ ⋮ & & & & ⋮ \\ {Z}_{n , 2} & {Z}_{n , 3} & ⋯ & {Z}_{n , 36} & {Z}_{n , 37}\end{matrix} ] & ( 18 ) \\ ZS = [ \begin{matrix}{b}_{1 , 1} & {b}_{1 , 2} & ⋯ & {b}_{1 , m} \\ {b}_{2 , 1} & ⋰ & & {b}_{2 , m} \\ ⋮ & & ⋰ & ⋮ \\ {b}_{36 , 1} & {b}_{36 , 2} & ⋯ & {b}_{36 , m}\end{matrix} ] & ( 19 )\end{matrix}$$

As the equation (16) indicates, the amount of any aberration can be defined by using the Zernike Sensitivity chart and the wavefront aberration data (for example, terms' coefficients of the Zernike polynomial in which the wavefront aberration is expanded, e.g. the second term's coefficient Z₂ through the 37^{th} term's coefficient Z₃₇). In other words, by specifying desired aberration values in the form of f in equation (16), and solving the equation (16) using the known (made beforehand) Zernike Sensitivity chart with the least-squares method, the values of terms' coefficients (e.g. the second term's coefficient Z₂ through the 37^{th} term's coefficient Z₃₇) of the Zernike polynomial for each measurement point within the field of the projection optical system can be determined which values make the amount of a specific aberration at a desired value.

That is, in the seventh method, the specification of the projection optical system is determined using as a standard the wavefront aberration (terms' coefficients of the Zernike polynomial in which the wavefront is expanded) for an aerial image of the pattern where the amount of a specific aberration, e.g., a line-width abnormal value (an index value of coma) is equal to or less than a predetermined value.

In any of the above first to seventh methods of determining the specification, the specification of the projection optical system is determined based on information of the target that the exposure apparatus must achieve, with using as a standard the information of the wavefront on the pupil plane of the projection optical system, that is, the overall information of light passing the pupil plane, and therefore by making the projection optical system satisfying the specification, the target of the exposure apparatus can be securely achieved.

b. The Process of Making a Projection Optical System

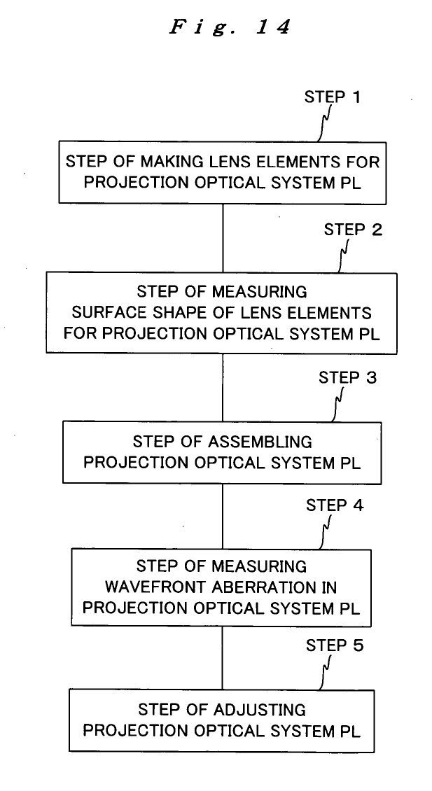

Next, the process of making a projection optical system will be described with reference to a flowchart in FIG. 14.

[Step 1]

First in a step 1, lens elements, lens holders for holding the lens element, and a lens barrel for housing optical units each comprising the lens element and the lens holder are made according to predetermined lens data in design which are optical members composing the projection optical system. That is, a known lens-processing apparatus processes predetermined optical materials to the lens elements such that these have a radius of curvature and a thickness along the axis, which were planned in design. And a known metal-processing apparatus processes predetermined material (stainless, brass, ceramic, etc.) to the lens barrel for housing the optical units comprising the lens element and the lens holder such that it has dimensions which were planned in design.

[Step 2]

In a step 2, the surface shapes of the lens elements of projection optical system PL made in the step 1 are measured by, for example, a Fizeau-type interferometer which employs a He—Ne gas laser emitting light having a wavelength of 633 nm, an Ar laser emitting light having a wavelength of 363 nm, or a light source which converts an Ar-laser light into a higher-harmonic wave having a wavelength of 248 nm from an Ar laser. The Fizeau-type interferometer measures by a pick-up unit such as CCD an interference fringe caused by light reflected by a reference surface on the surface of a condenser lens on the optical path and light reflected by the surface of a lens element to be measured, so that it can accurately obtain the shape of the surface to be measured. Obtaining the shape of the surface (lens surface) of an optical element such as a lens by using the Fizeau-type interferometer is known, and disclosed in, for example, Kokai (Japanese Unexamined Patent Application Publication) No. 62-126305 and Kokai (Japanese Unexamined Patent Application Publication) No. 6-185997, and thus its detailed description is omitted.

For the lens surfaces of all lens elements forming part of projection optical system PL, the measuring of the shape of the surface of an optical element using the Fizeau-type interferometer is performed, and the measurement results are stored in a memory such as RAM or a storage unit such as a hard disk of second communication server 130 through an input unit (not shown) such as a console.

[Step 3]

After the completion of, in step 2, measuring the shapes of the lens surfaces of all lens elements forming part of projection optical system PL, the plurality of optical units each comprising the lens element and a lens holder for holding the lens element which are processed according to design values are assembled individually. A plurality of, for example, four units of these optical units each have movable lens 13₁ through 13₄ and a double-structured lens holder described above which has an inner lens holder for holding movable lens 13₁ through 13₄ described previously and an outer lens holder for holding the inner lens holder, between which the positional relation are adjustable through a mechanical adjustment mechanism. The double-structured lens holder further comprises the above driving devices arranged in respective, predetermined positions.

Then the plurality of optical units are assembled individually by sequentially dropping them and a spacer each time between them into the lens barrel through its upper opening. The optical unit which was first dropped in the lens barrel is supported by a protrusion in the lower end of the lens barrel via a spacer, and when all the optical units have been accommodated in the lens barrel, the assembly ends. During the assembly, distances between the optical surfaces (lens surfaces) of the lens elements are measured by a tool (micrometer, etc.) with taking into account the thickness of the spacers to be accommodated in the lens barrel. And the assembly and the measurement are repeated to obtain final distances upon the completion of the assembly in the step 3 between the optical surfaces (lens surfaces) of the lens elements in projection optical system PL.

Incidentally, during the making process including the assembly, movable lenses 13₁ through 13₄ are fixed in their neutral positions. Although the explanation is omitted, pupil aperture stop 15 is installed in projection optical system PL in the assembly.

The results of measuring, during the assembly and upon its completion, distances between the optical surfaces (lens surfaces) of the lens elements in projection optical system PL are stored in a memory such as RAM or a storage unit such as a hard disk of second communication server 130 through the input unit (not shown) such as a console. It is remarked that in the assembly the optical units may be adjusted as needed.

At that time, relative distances along the optical axis between the optical elements are changed via, e.g., a mechanical adjustment mechanism, or the optical elements are tilted with respect to the optical axis. Moreover, the lens barrel may have a tapped hole made therein and a screw which screws through the tapped hole and which touches the lens holder so that the lens holder can be displaced in a direction perpendicular to the optical axis to adjust eccentricity, etc., thereof by screwing the screw with a tool such as a screw-driver.

[Step 4]

Next, a step 4 measures the wavefront aberration due to projection optical system PL assembled in the step 3.

Specifically, projection optical system PL is attached to the body of a large-sized wavefront measuring apparatus (not shown), and the wavefront aberration is measured. The principle of the wavefront measuring apparatus measuring the wavefront is the same as in wavefront-aberration measuring unit 80 and thus its detailed description is omitted.

As a result of measuring the wavefront, terms' coefficients Zᵢ(i=1, 2, through 81) of the Zernike polynomial (fringe Zernike polynomial) in which the wavefront in the projection optical system is expanded are obtained by the wavefront-measuring apparatus. Thus when second communication server 130 is connected with the wavefront measuring apparatus, the terms' coefficients Zᵢ of the Zernike polynomial are automatically stored in a memory such as RAM (or a storage unit such as a hard disk) of second communication server 130. While in the above description the wavefront measuring apparatus outputs the coefficients up to the 81^{st} term of the Zernike polynomial in order to calculate higher-order components of the aberrations due to projection optical system PL, coefficients up to the 37^{th} term as in the wavefront-aberration measuring unit or coefficients over the 81^{st} term may be output.

[Step 5]

In a step 5, projection optical system PL is adjusted based on the wavefront aberration measured in the step 4 such that the wavefront aberration satisfies the specification determined according to one of the first through seventh methods of determining the specification.

Before the adjustment of projection optical system PL, second communication server 130 reproduces optical data in the making process of projection optical system PL that has been assembled in actual, by correcting optical basic data stored beforehand, based on information in the memory, that is, the shape information of the surfaces of the optical elements obtained in the step 2, the information of distances between the optical surfaces of the optical elements obtained in the assembly of the step 3. The optical data is used to calculate adjustment amounts for the optical elements.

That is, a basic database for adjustment is already stored in the hard disk of second communication server 130. The basic database is obtained by expanding the so-called matrix O so as to contain non-movable lenses as well as the movable lenses, the matrix O being given by calculating a relation between a unit drive quantity in directions of each of six degrees of freedom of each of all the lens elements composing projection optical system PL and variation amounts of each term's coefficient Zᵢ based on design values of the projection optical system. Second communication server 130 performs a predetermined computation based on the optical data in the making process for projection optical system PL to correct the basic database for adjustment.

And when one of the first through sixth methods is selected, second communication server 130 calculates an adjustment amount of each lens element in directions of each of six degrees of freedom, according to a predetermined computing program and using, for example, the least-squares method, based on the corrected basic database, the target values for the wavefront, i.e. values that terms' coefficients Zᵢ of the Zernike polynomial to satisfy based on the selected method of determining the specification, and measured values of the terms' coefficients Zᵢ of the Zernike polynomial which are obtained as a result of measurement by the wavefront measuring apparatus.

Then second communication server 130 displays on screen information of adjustment amounts (including zero) of the lens elements in direction of each of six degrees of freedom.

According to the display, an engineer (or worker) adjusts the lens elements, so that projection optical system PL is adjusted so as to satisfy the specification determined according to the selected method of determining the specification.

Specifically, when the first method is selected as the method of determining the specification, projection optical system PL is adjusted such that the coefficients of specific terms selected based on the target information out of the terms of the Zernike polynomial in which the wavefront in projection optical system PL is expanded are not over the predetermined values. When the second method is selected, projection optical system PL is adjusted such that the RMS value of terms' coefficients of the Zernike polynomial in which the wavefront within the field of the projection optical system is expanded is not over the predetermined permissible value. When the third method is selected, projection optical system PL is adjusted such that terms' coefficients of the Zernike polynomial in which the wavefront in the projection optical system is expanded are not over the respective, predetermined permissible values that are set individually. When the fourth method is selected, projection optical system PL is adjusted such that the RMS value, within the field, of the coefficients of terms (n^{th} order, mθ terms) corresponding to a specific aberration being watched, out of the terms of the Zernike polynomial in which the wavefront in projection optical system PL is expanded is not over the predetermined permissible value. When the fifth method is selected, projection optical system PL is adjusted such that the RMS value, within the field, of the coefficients of each group of mθ terms having the same mθ value out of terms, which correspond to a specific aberration to be watched, out of the terms of the Zernike polynomial in which the wavefront within the field of the projection optical system is expanded is not over the respective, predetermined permissible values that are set individually. When the sixth method is selected, projection optical system PL is adjusted such that the RMS value, within the field, of coefficients given by weighting according to the target information the coefficients of the terms of the Zernike polynomial in which the wavefront in the projection optical system is expanded is not over the predetermined permissible value.

When the seventh method is selected, second communication server 130 performs a simulation for obtaining an aerial image formed on the image plane when the pattern is projected by projection optical system PL based on the pattern information contained in the target information, and analyzes the simulation result to adjust projection optical system PL such that the projection optical system satisfies the wavefront aberration amount allowed for transferring the pattern finely. In this case, as a method of the simulation, for example, second communication server 130 makes a Zernike Sensitivity chart similar to the one described earlier in advance, and obtains an aerial image based on a liner combination between sensitivities (Zernike Sensitivity) of coefficients of terms of the Zernike polynomial, in which the wavefront in the projection optical system is expanded, to a specific aberration (including its index value) when the pattern is a subject pattern, the sensitivities (Zernike Sensitivity) being obtained from the Zernike Sensitivity chart and the coefficients of terms of the Zernike polynomial in which the wavefront of the projection optical system is expanded. Then, second communication server 130 calculates an adjustment amount of each lens element based on the aerial image using, for example, the least squares-method, which makes the aberration being watched equal to or less than the permissible value.

Then second communication server 130 displays on screen information of adjustment amounts (including zero) for the lens elements in direction of each of six degrees of freedom. According to the display, an engineer (or worker) adjusts the lens elements, so that projection optical system PL is adjusted so as to satisfy the specification determined according to the seventh method of determining the specification.

In any of the methods, because projection optical system PL is adjusted based on a result of measuring the wavefront in the projection optical system, higher-order components of the wavefront aberration can be adjusted simultaneously as well as lower-order components, without considering the order of aberrations to be adjusted as in the prior art. Therefore, it is possible to adjust the optical properties of the projection optical system very accurately and easily, and projection optical system PL can be made which substantially satisfies the determined specification.

In this embodiment, after measuring the wavefront aberration in step 4, the not-adjusted projection optical system is installed in the exposure apparatus, and then the projection optical system is adjusted. However, the projection optical system adjusted may be installed in the exposure apparatus after having adjusted the projection optical system (reprocessing, replacement, etc., of optical elements). Here, for example, a worker may adjust the projection optical system by adjusting the positions of optical elements without using the imaging-characteristic adjusting mechanism. Further, it is preferable that the wavefront is measured again using wavefront-aberration measuring unit 80 or measurement reticle R_{T} after the projection optical system is installed in the exposure apparatus, and the projection optical system is readjusted based on the measurement result.

The above measurement of the wavefront upon the adjustment of projection optical system PL may be performed using the wavefront measuring apparatus, based on an aerial image formed via a pinhole and projection optical system PL. However, it is not limited to this, and the measurement may performed, for example, using measurement reticle R_{T}, based on the result of projecting the image of a predetermined measurement pattern of measurement reticle R_{T} on a wafer W through a pinhole and projection optical system PL.

It is remarked that in order to make easy reprocessing of optical elements of projection optical system PL, after identifying an optical element that needs reprocessing based on a result of the wavefront measuring apparatus measuring the wavefront aberration, reprocessing the optical element and readjusting other optical elements may be performed at the same time. Furthermore, if reprocessing or replacement of optical elements of the projection optical system is necessary, the reprocessing or replacement is preferably performed before installing the projection optical system in the exposure apparatus.

Next, the method of making exposure apparatus 122 will be described.

First in the making of exposure apparatus 122, illumination optical system 12 comprising optical elements and the like such as a plurality of lens elements and mirrors is assembled as a unit while projection optical system PL is assembled as a unit in the above way. And a reticle stage system and a wafer stage system, which each comprise a lot of mechanical elements, are assembled as individual units, and optical adjustment, mechanical adjustment, electric adjustment, etc., are performed so that these achieve desirable performance. During the adjustments, projection optical system PL is also adjusted in the above way.

Next, illumination optical system 12 and projection optical system PL are installed in an exposure-apparatus main body, and the reticle stage system and the wafer stage system are attached to the exposure-apparatus main body, and these are connected together with electric wires and pipes.

Then, optical adjustment is performed on illumination optical system 12 and projection optical system PL, because the imaging characteristics of the optical systems, particularly of projection optical system PL, slightly change, between before and after the installation in the exposure-apparatus main body. In this embodiment, upon the optical adjustment of projection optical system PL after being installed in the exposure-apparatus main body, the wavefront aberration is measured in the same way as above after having attached wavefront-aberration measuring unit 80 to Z-tilt stage 58. Wave-front information of measurement points as a result of measuring the wavefront aberration is sent via the network from main controller 50 of the exposure apparatus to second communication server 130. Second communication server 130 calculates adjustment amounts for the lens elements in directions of each of six degrees of freedom, for example, using the least-squares method, in the same way as in adjustment in the making of projection optical system PL as a single unit, and displays the calculation result on screen.

And according to the display, an engineer (or worker) adjusts the lens elements, so that projection optical system PL is made which securely satisfies the specification determined.

It is possible for main controller 50 to automatically perform the final adjustment in the manufacturing stage on projection optical system PL via imaging-characteristic correcting controller 48 according to instructions from second communication server 130 or based on the processing results using the first program, the second program and database, the fourth program, and the like. However, the movable lenses are preferably kept in their neutral positions after the completion of making the exposure apparatus in order to ensure enough drive stroke of driving devices just after having introduced into a semiconductor-manufacturing factory. Furthermore, because the aberrations that are not corrected at this point, mainly higher-order components of the wavefront aberration can be judged as aberration difficult to correct automatically, the positions of the lenses and the like are preferably readjusted.

Alternatively, a worker who performs adjustment in the manufacturing stage may input instructions (including input of condition setting and input of information related to the projection optical system) like the adjustment described earlier. In response to the input, the CPU in main controller 50 performs processes according to the fourth program and a similar Zernike Sensitivity chart is made. Then, the wavefront aberration of projection optical system PL is measured in the procedure previously described using measurement reticle R_{T} also described earlier. And, by inputting the measurement results of wavefront aberration to main controller 50, the CPU in main controller 50 performs processing according to the first and fourth programs previously described, and the aim aberration is sequentially calculated. Then, instruction values on drive amount of movable lenses 13₁ to 13₄ in directions of each degree of freedom are given to imaging-characteristic correcting controller 48 that optimizes (zero or minimal) such aim aberration. With this operation, imaging-characteristic correcting controller 48 adjusts the aim imaging characteristic of projection optical system PL such as distortion, field curvature, coma, spherical aberration, and astigmatism, with as much precision as possible.

Then, for the purpose of confirming the adjustment results, the simulation referred to earlier is performed again and astigmatism, field curvature, a line-width abnormal value corresponding to coma, and the like of projection optical system PL that has been adjusted is displayed on screen. The aberrations that are not corrected at this point, mainly higher-order aberration, can be judged as aberration difficult to adjust automatically, therefore, the lens assembly can be re-adjusted if necessary.

It is remarked that for example when the above readjustment does not yield a desirable performance, some lenses need to be reprocessed or replaced. In order to make easy reprocessing of optical elements of projection optical system PL, as is described above, an optical element that needs reprocessing may be identified based on a result of a wavefront measuring apparatus measuring the wavefront aberration in projection optical system PL before installing projection optical system PL in the exposure-apparatus main body, or reprocessing the optical element and readjusting other optical elements may be performed at the same time.

Moreover, optical elements of projection optical system PL may be individually replaced or, when the projection optical system has a plurality of lens barrels, lens barrels as units may be replaced. Furthermore, in reprocessing the optical element, its surface may be processed so as to become non-spherical, if necessary. Yet further, in adjusting projection optical system PL only the position (or distance from another), tilt, etc., of an optical element thereof may be changed, or, when the optical element is a lens, its eccentricity may be changed, or it may be rotated around optical axis AX.

After that, overall adjustment (electrical adjustment, operation verification, etc.) is performed. By this, exposure apparatus 122 in the embodiment has been made which can accurately transfer a pattern on a reticle R onto a wafer W by projection optical system PL whose optical properties have been adjusted very accurately. It is remarked that the making of the exposure apparatus is preferably performed in a clean room where the temperature and cleanliness are controlled.

As described above, according to computer system 10 in the embodiment and the methods of determining the specification of the projection optical system, the specification of the projection optical system is determined based on target information that exposure apparatus 122 should achieve and a given standard of the wavefront aberration due to projection optical system PL. That is, the specification of the projection optical system is determined using a given standard of information of the wavefront on the pupil plane of the projection optical system. Therefore, projection optical system PL is adjusted based on a result of measuring the wavefront aberration, for example, in making projection optical system PL according to the determined specification, so that higher-order components of the wavefront aberration are simultaneously adjusted as well as lower-order components. Thus compared with the prior art where in the making stage, after the adjustment of the projection optical system for correcting lower-order components, the adjustment of the projection optical system for correcting higher-order components is performed based on a result of detecting the higher-order components by ray-tracing, the process of making the projection optical system is obviously simple. In addition, because the specification is determined based on the target information, the exposure apparatus comprising the projection optical system can securely achieve the target.

In addition, in this embodiment, in adjusting projection optical system PL in the process of making the projection optical system and exposure apparatus, after determining the specification and measuring the wavefront aberration due to projection optical system PL, projection optical system PL is adjusted based on the measurement result so as to satisfy the specification. Therefore, projection optical system PL can be easily and securely made which satisfies the specification. Thus, sequentially performing the adjustments for lower-order components and for higher-order components and ray-tracing for the adjustment as in the prior art are not needed, so that the process of making projection optical system PL becomes simpler and that exposure apparatus 122 comprising the projection optical system securely achieves the target.

In this embodiment, both before and after installing projection optical system PL in the exposure-apparatus main body, the wavefront aberration is measured. In the former, the wavefront-aberration measuring apparatus very accurately measures the wavefront in the projection optical system, and in the latter the optical properties of the projection optical system can be very accurately adjusted regardless of whether or not environmental conditions are different between before and after installing projection optical system PL in the exposure-apparatus main body. Alternatively, either before or after installing projection optical system PL in the exposure-apparatus main body, the wavefront aberration may be measured.

In any of the cases, because projection optical system PL is adjusted based on a result of measuring the wavefront in the projection optical system, higher-order components of the wavefront aberration can be adjusted simultaneously as well as lower-order components, without considering the order of aberrations to be adjusted as in the prior art. Therefore, it is possible to adjust the optical properties of the projection optical system very accurately and easily, and projection optical system PL can be made which substantially satisfies the determined specification.

According to exposure apparatus 122 in the embodiment, main controller 50 measures the wavefront in projection optical system PL via wavefront-aberration measuring unit 80 (or measurement reticle R_{T}) as described above, and controls the imaging-characteristic adjusting mechanism (48, 13₁ through 13₄), etc., using the result of measuring the wavefront, which provides overall information on light passing through the pupil plane of the projection optical system. Therefore, the imaging characteristic of projection optical system PL is automatically adjusted using the result of measuring the wavefront, so that the imaging state of a pattern by projection optical system PL is adjusted to be fine.

In addition, because exposure apparatus 122 in the embodiment comprises projection optical system PL that has been made according to the making method and adjusted in terms of higher-order components of the wavefront aberration as well as lower-order components in the later adjustment as well as in the making process, a pattern of a reticle R can be accurately transferred onto a wafer W by projection optical system PL.

According to the exposure apparatus in the embodiment, when the measuring unit (such as R_{T} and 50) measures the wavefront aberration of projection optical system PL according to instructions from the operator, and main controller 50 calculates the aim imaging characteristic of projection optical system PL, based on the wavefront aberration of projection optical system PL which has been measured and the Zernike Sensitivity Chart of the aim imaging characteristic corresponding to the aberration information given when the subject pattern was exposed. By using the Zernike Sensitivity Chart in the manner described above, the aim imaging characteristic can be calculated with only one measuring of the wavefront aberration. In this case, in the measuring, as for spherical aberration, astigmatism, and coma, not only the lower-order aberration, but also a total aberration including the higher-order aberration can be calculated.

In addition, since the aim imaging characteristic is corrected as much as possible by imaging-characteristic adjusting unit (48 and 50) based on the calculation results of the aim aberration (imaging characteristic), the imaging characteristic of projection optical system PL is consequently adjusted according to the subject pattern.

In addition, according to exposure apparatus 122 in the embodiment, parameters that denote a relation between the adjustment of specific optical elements for adjustment (movable lenses 13₁ through 13₄) and the variation of the imaging characteristic of projection optical system PL are obtained in advance, and the parameters are stored as a database in storage unit 42. And, based on instructions from a service engineer or the like on adjustment, the wavefront aberration of projection optical system PL is actually measured, and then when the measurement data (actual measurement data) is input via input unit 45, main computer 50 calculates the target adjustment amount of movable lenses 13₁ through 13₄, using the actual measurement data of the wavefront aberration input via input unit 45 and a relation expression between the parameters and the target adjustment amount of movable lenses 13₁ through 13₄ (equation(11) or equation (13) described earlier). Because the above parameters are obtained in advance and stored in storage unit 42, when the wavefront aberration is actually measured, the target adjustment amount of movable lenses 13₁ through 13₄ for correcting the wavefront aberration can be easily calculated by simply inputting the actual measurement values of the wavefront aberration via input unit 45. In this case, data that are difficult to obtain, such as the design data of the lenses are not necessary, as well as a difficult ray-tracing calculation.

Then, the target adjustment amount is given as instruction values to imaging-characteristic correcting controller 48 from main controller 50, and imaging-characteristic correcting controller 48 adjusts movable lenses 13₁ through 13₄ according to the target adjustment amount, performing a simple but highly precise adjustment on the imaging characteristic of projection optical system PL.

In addition, according to exposure apparatus 122 in the embodiment, when exposure is preformed, because the pattern of reticle R is transferred onto wafer W via projection optical system PL whose imaging characteristic is adjusted in the manner described above according to the subject pattern or whose imaging characteristic is adjusted with high precision based on the measurement results of wavefront aberration, fine patterns can transferred onto wafer W with good overlay accuracy.

In addition, according to computer system 10 in the embodiment, wavefront-aberration measuring unit 80 of exposure apparatus 122 measures the wavefront in projection optical system PL. First communication server 120 sends the result of wavefront-aberration measuring unit 80 measuring the wavefront in projection optical system PL to second communication server 130 via a communication path. Second communication server 130 controls the imaging-characteristic adjusting mechanism (48, 13₁ through 13₄), using the result of measuring the wavefront. Therefore, the imaging characteristic of projection optical system PL is accurately adjusted using information of the wavefront on the pupil plane of the projection optical system, that is, overall information on light passing through the pupil plane. As a consequence, the imaging state of the pattern by projection optical system PL is adjusted to be optimal. Second communication server 130 can be disposed in a remote position from exposure apparatus 122 and first communication server 120 connected thereto, and in such a case the imaging characteristic of projection optical system PL and thus the imaging state of the pattern by projection optical system PL can be very accurately adjusted in remote control.

According to computer system 10 in the embodiment and the method of determining optimum conditions performed by computer system 10, when a host computer managing exposure apparatus 122 or an operator inputs information on exposure conditions including information on a predetermined pattern into first communication server 120, second communication server 130 repeats the simulation for obtaining an aerial image of the pattern that is formed on the image plane when projection optical system PL projects the pattern, based on the information on the pattern included in the information on exposure conditions received from first communication server 120 via a communication path and known aberration information of projection optical system PL, and determines optimum exposure conditions by analyzing the simulation results. Therefore, the optimum exposure conditions can be almost automatically set.

According to computer system 10 in the embodiment, when adjusting projection optical system PL upon the maintenance of exposure apparatus 122 or the like, a service engineer, etc., attaches wavefront-aberration measuring unit 80 to Z-tilt stage 58 and simply instructs to measure wavefront aberration via input unit 45, and then the imaging characteristic of projection optical system PL can be almost automatically adjusted with high precision in remote control by second communication server 130. Alternatively, a service engineer or the like, using measurement reticle R_{T}, may measure the wavefront aberration due to projection optical system PL of exposure apparatus 122 in the above procedure, and input data of a position deviation amount obtained by the measurement into main controller 50 of exposure apparatus 122, in which case also the imaging characteristic of projection optical system PL can be adjusted with high precision in remote control by second communication server 130.

Furthermore, with exposure apparatus 122 in the embodiment, since the optimum exposure conditions are set upon exposure, and a pattern on reticle R is transferred onto wafer W via projection optical system PL whose imaging characteristic has been adjusted accurately, a fine pattern can be transferred onto wafer W with good overlay accuracy.

Although the above embodiment describes the case where an adjusting unit for adjusting the imaging state of a pattern by projection optical system PL is constituted by the imaging-characteristic adjusting mechanism for adjusting the imaging characteristic of projection optical system PL, this invention is not limited to this. The adjusting unit may alternatively or additionally include, for example, a mechanism which drives at least one of reticle R and wafer W in the optical-axis AX direction or a mechanism which shifts the wavelength of illumination light EL. For example when using the mechanism which shifts the wavelength of illumination light EL together with the imaging-characteristic adjusting mechanism, the adjustment of the imaging characteristic, as in the case of the movable lenses, is possible by using the variation of the imaging characteristic in each of a plurality of measurement points within the field of projection optical system PL, specifically wavefront data, for example the variations of the second term's coefficient through the 37^{th} term's coefficient of the Zernike polynomial relative to a unit shift amount of illumination light EL, which were obtained by the above simulation, etc., and contained in the database beforehand. That is, by performing the least-squares computation according to the above second program using the database, calculation of an optimum shift amount of the wavelength of illumination light EL for adjusting the imaging state of the pattern by the projection optical system can be performed easily, and the wavelength can be automatically adjusted based on the calculation result.

In the above embodiment, the case has been described where on simulation, various types of information including information on the subject pattern, information on the aim imaging characteristic, information on the projection optical system, and information on the aberration that is to be given is input to main controller 50 via input unit 45 such as a keyboard, and based on such information, main controller 50 makes a Zernike Sensitivity Chart of the aim imaging characteristic that corresponds to the aberration information given when main controller 50 exposed the subject pattern. However, the present invention is not limited to this. That is, the fourth program may be installed into a different simulation computer other than main controller 50, and various assumptions may be made on information such as the object pattern and information on the projection optical system. And based on each assumption, input operation may be repeatedly performed to make the Zernike Sensitivity Charts of various types corresponding to the input information in advance, while sequentially changing the condition setting, as well as the information on the aim aberration, the information on the projection optical system, and the information on the aberration that is to be given, and from these sensitivity charts a database may be made, which may be stored in the CD-ROM along with the first and second programs.

When the database made up of the Zernike Sensitivity Chart of various types described above is made in advance, a program (hereinafter called “the fifth program” for the sake of convenience) is to be prepared, which is a simplified program of the fourth program to make the CPU in main controller 50 perform the computation previously described using a corresponding Zernike Sensitivity Chart in response to the input of the measurement results of the wavefront aberration and setting conditions and to make the CPU immediately calculate and display the aim aberration. The fifth program is to be stored in the above CD-ROM.

Then, on simulation, the first and fifth programs in the CD-ROM are installed on storage unit 42, and at the same time the database consisting of the Zernike Sensitivity Chart is copied to storage unit 42. Or, only the first and fourth programs in the CD-ROM may be installed on storage unit 42 and the CD-ROM may be left in drive unit 46. In the latter case, on simulation, main controller 50 is to read the data of the Zernike Sensitivity Chart from the CD-ROM when necessary. In this case, the CD-ROM set inside drive unit 46 makes up the storage unit. This can be accomplished, by modifying the software.

In the above embodiment, the case has been described where a wavefront aberration, which is an overall aberration, is measured as the imaging characteristics of the projection optical system, and the target adjustment amount of the movable lenses (specific optical elements for adjustment) for correcting the wavefront aberration is calculated, according to the measurement results. However, the present invention is not limited to this. For example, the imaging characteristics of the projection optical system subject to adjustment may be individual imaging characteristics, such as coma or distortion. In this case, for example, a relation between the unit quantity adjustment amount of the specific optical elements for adjustment in directions of each degree of freedom and the variation amount of the individual imaging characteristics such as coma or distortion is obtained by simulation, and based on the results, parameters denoting the relation between the adjustment of the specific optical element and the variation in the imaging characteristics of the projection optical system is obtained, and then a database is made by the parameters. Then, when actually adjusting the imaging characteristics of the projection optical system, by obtaining coma (or a line-width abnormal value), distortion, or the like of the projection optical system using, for example, the exposing method or aerial image measurement method, and inputting the measurement values to the main controller, the target adjustment amount of the specific optical element can be decided by calculation likewise the above embodiment, using a relation equation between the imaging characteristic that has been obtained, the parameters, and the target adjustment amount of the specific optical element (such relation expression is to be prepared in advance).

Incidentally, the first program, the second program (and its database), the third program and the fourth program are programs that have different purposes, which means that they all have sufficient utility values independently.

Especially with the fourth program, a part of it that makes the Zernike Sensitivity Chart (corresponding to steps 101 through 122) can be used as a single program. By inputting various types of information including information on a subject pattern, information of the targeted imaging characteristic, information on the projection optical system, and information on a given aberration from an input unit such as a keyboard into a computer that has such a program installed, the Zernike Sensitivity Chart of the aim imaging characteristic is made. Accordingly, the database consisting of the Zernike Sensitivity Chart made in the manner above can be suitably used in other exposure apparatus as is previously described.

In addition, especially with the second program and the fourth program, they do not necessarily have to be combined because their purposes differ greatly. The purpose of the former is to make the operation efficient for a service engineer or the like performing repair and adjustment on the exposure apparatus when the imaging characteristics of the projection optical system need to be adjusted, whereas, the purpose of the latter is to perform a simulation to confirm whether the aim imaging characteristic of the projection optical system is sufficient enough when the operator or the like of the exposure apparatus in a semiconductor manufacturing site exposes a subject pattern. When taking into consideration such differences in their purposes, in the case the second program and its database and the fourth program are in the same software package as in the above embodiment, for example, two types of passwords is settable. In such a case, the second and fourth program may be supplied as a different information storage medium such as a firmware, and only the database may be recorded in a storage medium such as the CD-ROM.

In addition, in the above embodiment, on the adjustment of the imaging characteristic of projection optical system PL, the first, second and fourth programs were installed on storage unit 42 from the CD-ROM, and the database was copied to storage unit 42. The present invention, however, is not limited to this, and so long as only the first, second and fourth programs are installed on storage unit 42 from the CD-ROM, the database does not have to be copied to storage unit 42. In this case, the CD-ROM set in the drive unit structures the storage unit.

In the above embodiment, the case has been described where the database is made up of parameters corresponding to the unit drive amount of movable lenses 13₁ to 13₄ in directions of each degree of freedom. However, the present invention is not limited to this, and in cases such as when a part of the lens making up projection optical system PL can be easily exchanged, parameters that show the variation of the imaging characteristics corresponding to the thickness of the lens may be included. In such a case, the optimal lens thickness is to be calculated as the target adjustment amount. Besides such parameters, the database may include parameters that show the variation of the imaging characteristics corresponding to reticle Rotation. In this case, for example, when reticle R rotates as is shown in FIG. 5F, such rotation may be in a+ (positive) direction, and the unit rotation amount may be 0.1 degrees. In this case, according to the calculated reticle rotation, for example, only at least one of reticle stage RST and wafer stage WST has to be rotated. And, other than such parameters, details whose variation affects the imaging characteristics of the projection optical system and is also adjustable can also be included in the database, such as center wavelength of the illumination light, or the position of the reticle or the like in the optical axis direction.

In addition, in the above embodiment, the case has been described where main controller 50 automatically adjusts the imaging characteristics of projection optical system PL via imaging-characteristic correcting controller 48, based on the target adjustment amount of the specific optical elements computed according to the second program or the aim aberration amounts computed according to the fourth program. However, the present invention is not limited to this, and the imaging characteristic of projection optical system PL may be adjusted manually by an operator or via an operation. In such a case, the second program or the fourth program can be effectively used not only in the adjustment stage, but also in the manufacturing stage, which allows production of a projection optical system whose imaging characteristics are adjusted.

Although the above embodiment describes the case of using the exposure apparatus as an optical apparatus, not being limited to this, the optical apparatus only has to comprise a projection optical system.

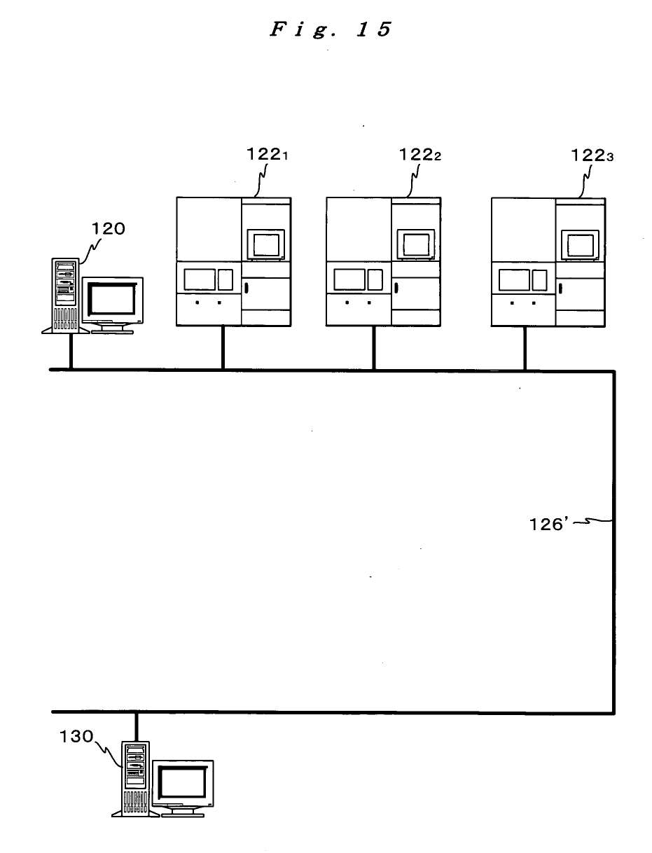

Although the above embodiment describes the computer system where first communication server 120 as the first computer and second communication server 130 as the second computer are connected with each other via a communication path including the public telephone line, this invention is not limited to this. For example, as shown in FIG. 15, it may be a computer system where first communication server 120 and second communication server 130 are connected with each other via LAN 126′ as a communication path, such as an in-house LAN system installed in the research-and-development section of an exposure-apparatus maker.

In the construction of such an in-house LAN system, first communication server 120 is installed on a clean room side in the research-and-development section such as a place where an exposure apparatus is assembled and adjusted (hereinafter, called a “site”), and second communication server 130 is installed in an office remote from the site. And an engineer in the site sends measurement data of the wavefront aberration and information of exposure conditions (including pattern information) for an exposure apparatus under experiment to second communication server 130 on the office side via first communication server 120. And an engineer on the office side instructs second communication server 130 to perform automatic correction of the imaging characteristic of projection optical system PL of exposure apparatus 122 based on the received information, in which server. 130 a program being developed by them is already installed, and receives the result of measuring the wavefront aberration due to projection optical system PL after the adjustment of the imaging characteristic to confirm the effect of the adjustment of the imaging characteristic. The result can also be used in developing the program.

Alternatively, an engineer in the site may send pattern information from first communication server 120 to second communication server 130 and make it determine an optimum specification of the projection optical system for the pattern.

In addition, first communication server 120 and second communication server 130 may be connected with each other by radio.

Although the above embodiment and modified examples describe a case where a plurality of exposure apparatuses 122₁ through 122₃ are arranged and second communication server 130 is commonly connected with exposure apparatuses 122₁ through 122₃ via a communication path, this invention is not limited to this, and there may be only one exposure apparatus.

Although the above embodiment describes the case of determining the specification of the projection optical system using computer system 10, the technical idea of determining the specification of the projection optical system using a standard for the wavefront can be used irrelevantly to computer system 10. That is, in a business between the makers A and B, the maker B may receive pattern information or the like from the maker A and determine the optimum specification of the projection optical system for the pattern using a standard for the wavefront. Also this case has the advantage, when making the projection optical system based on the specification determined using a standard for the wavefront, that the process thereof is simpler.

In addition, in the above embodiment, second communication server 130 calculates adjustment amounts ADJ1 through ADJm of movable lenses 13₁ through 13₄ using the second program and based on the result of measuring the wavefront aberration of the projection optical system of exposure apparatus 122, and sends the adjustment-amounts data to main controller 50 of exposure apparatus 122, which gives imaging-characteristic correcting controller 48 instruction values according to the adjustment-amounts ADJ1 through ADJm to drive movable lenses 13₁ through 13₄ in direction of each degree of freedom, so that the adjustment of the imaging characteristic of projection optical system PL is performed in remote control. However, not being limited to this, exposure apparatus 122 may be constructed to automatically adjust the imaging characteristic of the projection optical system based on the result of measuring the wavefront aberration and using the same program as the second program.

Note that in the manufacturing of microprocessors for example, when forming gates, a phase-shift reticle as a phase-shift mask, particularly, a phase-shift reticle of a space-frequency-modulation-type (Levenson type) is used together with small σ illumination. Specifically, under an illumination condition that a coherence factor (σ value) is smaller than 0.5, preferably below about 0.45, the phase-shift reticle is illuminated. Here, the best focus position within the exposure area to which illumination light for exposure is irradiated (which is conjugate with the illumination area with respect to the projection optical system and is a projection area on which a pattern image of a reticle is formed) in the field of the projection optical system deviates due to the aberrations of the projection optical system (e.g. astigmatism, spherical aberration, etc.) and the depth of focus is smaller.

Therefore, in the making of the projection optical system, by adjusting the aberrations of the projection optical system (e.g. field curvature, astigmatism, spherical aberration, etc.) based on the deviation of the best focus position (i.e. imaging surface) within the exposure area of the projection optical system due to the use of the phase-shift reticle, the best focus position within the exposure area is preferably displaced partially and deliberately. In this case, focus-correction for correcting the aberrations may be performed beforehand so as to make a so-called overall focus difference small. By this, the deviation of the best focus position upon using the phase-shift reticle is greatly reduced and the pattern image of the phase-shift reticle is transferred onto a wafer with a larger depth of focus than before.

Furthermore, the same problem may occur when a phase-shift reticle is used in an exposure apparatus in a device-manufacturing factory. Therefore, the best focus position within the exposure area is preferably displaced partially and deliberately by adjusting the aberrations with using a mechanism for adjusting the imaging characteristic of the projection optical system (such as a mechanism that drives at least one optical element of the projection optical system via an actuator (piezo element, etc.)). Here, at least one of the field curvature and astigmatism or additionally the spherical aberration in the projection optical system is adjusted. Also in this case, focus-correction for correcting the aberrations may be performed beforehand to make the overall focus difference small.

Before the adjustment of the projection optical system, the imaging characteristic thereof, mainly the imaging surface (representing the best focus positions in the exposure area) may be obtained by computing from design data of the projection optical system (simulation) or by actually measuring the imaging characteristic.

In the former case, a method of computing by using the Zernike Sensitivity Chart described in the embodiment may be used. In the latter case, the imaging characteristic may be obtained from the wavefront aberration measured, or from the result of detecting the pattern image of the reticle by an aerial-image measuring unit having a light-receiving surface on the wafer stage or from the result of detecting an image of the reticle's pattern (latent image or resist image) transferred onto a wafer.

Here, it is preferable that arranging a phase-shift section to a pattern of a reticle and using small σ illumination, that is, under almost the same exposure conditions as in manufacturing devices, a pattern image is formed, and the imaging characteristic of the projection optical system is obtained.

In addition, the imaging characteristic of the projection optical system in which the deviation of the best focus position upon using the phase-shift reticle is reduced is measured again after the assembly or adjustment.

At this point of time, the deviation of line width in the best focus position surface may occur due to residual aberration in the projection optical system. If the deviation is above a permissible value, at least part of the projection optical system needs to be replaced or readjusted to make the aberration in the projection optical system smaller.

Here, optical elements of the projection optical system may be individually replaced or, when the projection optical system has a plurality of lens barrels, lens barrels as units may be replaced. Furthermore, at least one optical element may be reprocessed, and especially when the optical element is a lens, its surface may be processed so as to become non-spherical, if necessary. The optical element is a dioptric element such as a lens or a catoptric element such as a concave mirror or an aberration-correcting plate for correcting the aberrations (distortion, spherical aberration, etc.), especially, non-rotation-symmetry components due to the projection optical system. Further, in adjusting the projection optical system, only the position (including distance from another), tilt, etc., of an optical element thereof may be changed or, when the optical element is a lens, its eccentricity may be changed or it may be rotated around the optical axis. Such adjustment (replacement, reprocess, etc.) may also be performed in the above embodiment.

Although the above embodiment describes the case where measurement reticle R_{T} has a reference pattern as well as a measurement pattern, the reference pattern is not necessarily provided on an optical-property measurement mask (in the above embodiment, measurement reticle R_{T}). That is, the reference pattern may be provided on another mask or on the substrate (wafer) side and not on the mask side. That is, a reference wafer where a reference pattern having a size in accordance with the projection magnification is formed in advance is used, and the reference wafer is coated with a resist, then a measurement pattern is transferred onto the resist layer and development is performed. By measuring the position deviation of the measurement pattern's resist image obtained after the development from the reference pattern on the reference wafer, substantially the same measurement as in the above embodiment is possible.

Although in the above embodiment, after transferring the measurement and reference patterns on wafer W, the wavefront aberration due to projection optical system PL is calculated based on the result of measuring the resist images which are obtained by developing the wafer, not being limited to this, the result of measuring the image (aerial image) of the measurement pattern projected onto a wafer using the aerial-image measuring unit or the like, or of measuring the latent images of the measurement and reference patterns formed in the resist layer or images formed by etching a wafer may be used. Also in this case, the wavefront aberration of the projection optical system can be obtained in the same procedure as in the above embodiment based on the result of measuring the position deviation of the measurement pattern from a reference position (e.g. projection position of the measurement pattern planned in design). Instead of transferring the measurement pattern onto the wafer, after transferring the reference pattern onto the resist layer on a reference wafer on which the measurement pattern is already formed, the position deviation of the measurement pattern from the reference pattern may be measured by, e.g., using an aerial-image measuring unit having a plurality of apertures corresponding to the measurement pattern. Moreover, although in the above embodiment the overlay-measuring unit measures the position deviation, for example, the alignment sensor or the like arranged in the exposure apparatus may be used.

While in the above embodiment the coefficients up to the 37^{th} term of the Zernike polynomial are used, the coefficients over the 37^{th} term, e.g. up to the 81^{st} term, of the Zernike polynomial may be used to calculate higher-order components of the aberrations due to projection optical system PL. That is, this invention is irrelevant to the number of terms, and term numbers, of the Zernike polynomial in use. In addition, depending on the illumination condition the aberration in projection optical system PL may be caused deliberately, and thus in the above embodiment the optical elements of projection optical system PL may be adjusted for the aim aberration to take on a predetermined value and not zero or minimum.

In the above embodiment, first communication server 120 inquires information of reticle to be used this time in, for example, exposure apparatus 122₁ from the host computer (not shown) managing the exposure apparatuses 122₁ through 122₃ and, based on the reticle information, searches a predetermined database to obtain the pattern information, or alternatively an operator inputs the pattern information into first communication server 120 via an input unit. However, not being limited to this, the exposure apparatus may further comprise a reader BR such as a bar-code reader indicated by an imaginary line in FIG. 2, by which first communication server 120 reads a bar-code, two-dimensional code, etc., attached to reticle R being carried to reticle stage RST, via main controller 50 in order to obtain the pattern information.

In addition, in the case of measuring the wavefront aberration using the measurement reticle for example, alignment system ALG that the exposure apparatus comprises may detect the position deviation of the latent image of the measurement pattern from that of the reference pattern, the two latent images being formed in the resist layer on the wafer. Moreover, in the case of measuring the wavefront aberration using a wavefront-aberration measuring unit for example, a wavefront-aberration measuring unit having such a shape that it can replace the wafer holder may be used. In this case, the wavefront-aberration measuring unit can be automatically transported by a transport system (a wafer loader or the like) for replacing a wafer or wafer holder. By implementing the above various means, computer system 10 can automatically adjust the imaging characteristic of projection optical system PL and set the best exposure conditions without the help of an operator or service engineer. Although this embodiment describes the case where wavefront-aberration measuring unit 80 is attachable to and detachable from the wafer stage, wavefront-aberration measuring unit 80 may be fixed on the wafer stage, in which case a part of wavefront-aberration measuring unit 80 may be provided on the wafer stage while the rest is disposed separately from the wafer stage. Although in this embodiment, wavefront aberration due to the light-receiving optical system of wavefront-aberration measuring unit 80 is neglected, the wavefront aberration in the projection optical system may be determined in view of the wavefront aberration due to the light-receiving optical system.

In addition, exposure apparatus 122 alone may automatically adjust the imaging characteristic of projection optical system PL and set the best exposure conditions by using the first through fourth programs and databases associated therewith, described in the above embodiment, which are stored beforehand in an information storage media or storage unit 42 set in drive unit 46 of exposure apparatus 122. Furthermore, the first through fourth programs may be stored in an exclusive server (equivalent to second communication server 130) that is disposed in the factory of the maker A and connected to the exposure apparatuses through LAN. The point is that this invention is not limited to the construction in FIG. 1, and that it does not matter where a computer (server, etc.) storing the first through fourth programs is disposed.

Although the above embodiment describes the case where a stepper is used as the exposure apparatus, not being limited to this, a scan-type exposure apparatus may be used that is disclosed in, for example, U.S. Pat. No. 5,473,410 and that transfers a pattern of a mask while moving synchronously the mask and a substrate, or an exposure apparatus by the step-and-stitching method or the like may be used.

Besides, the present invention may be applied to an immersion exposure apparatus that has a liquid filled in the space between a projection optical system and a wafer whose details are disclosed in, for example, the Pamphlet of International Publication No. WO 2004/053955 or the like.

In addition, in the embodiment above, a mask of the light transmitting type is used, which is a substrate of the light transmitting type where a predetermined light-shielding pattern (or a phase pattern or an extinction pattern) is formed. However, instead of the mask above, an electronic mask (or a variable shaped mask, for example, DMD (Digital Micro-mirror Device) that is a type of non-emissive image display device (also called as a spatial light modulator) is included)) which forms a transmittance pattern, a reflection pattern, or an emission pattern, based on the electronic data of the pattern that is to be exposed, as is disclosed in, for example, U.S. Pat. No. 6,778,257.

This invention can be applied not only to an exposure apparatus for manufacturing semiconductor devices but also to an exposure apparatus for transferring a liquid crystal display device pattern onto a rectangular glass plate and an exposure apparatus for producing membrane-magnetic heads, micro machines, DNA chips, etc. Furthermore, this invention can be applied to an exposure apparatus for transferring a circuit pattern onto glass plates or silicon wafers to produce masks or reticles used by a light exposure apparatus, an EUV exposure apparatus, an X-ray exposure apparatus, a charged-particle-beam exposure apparatus employing an electron or ion beam, etc.

In addition, the light source may be an ultraviolet pulse illuminant such as an F₂ laser, ArF excimer laser or KrF excimer laser or a continuous illuminant such as an ultra-high pressure mercury lamp emitting an emission line such as g-line (a wavelength of 436 nm) or i-line (a wavelength of 365 nm).

Moreover, a higher harmonic wave may be used which is obtained with wavelength conversion into ultraviolet by using non-linear optical crystal after having amplified a single wavelength laser light, infrared or visible, emitted from a DFB semiconductor laser device or a fiber laser by a fiber amplifier having, for example, erbium (or erbium and ytterbium) doped. Furthermore, the projection optical system is not limited in magnification to a reduction system and may be an even-ratio or magnifying system. Yet further, the projection optical system is not limited to a dioptric system and may be a catadioptric system having catoptric elements and dioptric elements or a catoptric system having only catoptric elements. It is remarked that, when the catadioptric system or the catoptric system is used as the projection optical system, the imaging characteristic of the projection optical system is adjusted by changing the positions, etc., of the catoptric elements (concave mirror, reflective mirror, etc.) as the above-mentioned movable optical elements. When F₂ laser light, Ar₂ laser light, EUV light, or the like is employed as illumination light EL, projection optical system PL may be a catoptric system having only catoptric elements, and when Ar₂ laser light, EUV light, or the like is employed, a reticle R needs to be of a reflective type.

It is remarked that the process of manufacturing semiconductor devices comprises the steps of designing function/performance of the devices; making reticles according to the function/performance planned in the designing step; making wafers from silicon material; transferring the pattern of the reticle onto the wafer by using the exposure apparatus in the embodiment; assembling the devices (including the steps of dicing, bonding, and packaging); and inspection. According to this device manufacturing method, because the exposure apparatus in the embodiment performs exposure in a lithography step, the pattern of a reticle R is transferred onto a wafer W through projection optical system PL whose imaging characteristic is very accurately adjusted according to a subject pattern to be transferred or based on the result of measuring the wavefront aberration, and therefore it is possible to transfer a fine pattern onto wafer W with high overlay accuracy, so that the yield of the devices as final products and the productivity are improved.

While the above-described embodiments of the present invention are the presently preferred embodiments thereof, those skilled in the art of lithography systems will readily recognize that numerous additions, modifications, and substitutions may be made to the above-described embodiments without departing from the spirit and scope thereof. It is intended that all such modifications, additions, and substitutions fall within the scope of the present invention, which is best defined by the claims appended below.

What is claimed is:

1. An exposure apparatus that transfer a pattern onto an object via a projection optical system, said apparatus comprising:
a movable body that is arranged on an image plane side with respect to said projection optical system;
a wavefront measuring unit at least a part of which is arranged on the movable body and that measures wavefront information of said projection optical system;
an adjusting unit that adjusts an imaging state of a projected pattern that is generated on said object via said projection optical system; and
a controller that controls said adjusting unit using said wavefront information and Zernike Sensitivity corresponding to exposure conditions of said object.

2. The exposure apparatus of claim 1 wherein
said controller determines adjustment information of said projection optical system using the least-squares method, based on said wavefront information and said Zernike Sensitivity, and controls said adjusting unit based on the adjustment information.

3. The exposure apparatus of claim 2 wherein
said controller determines an adjustment amount of an optical element of said projection optical system as said adjustment information, based on data regarding a relation between an adjustment amount of the optical element of said projection optical system and variation of coefficient in a predetermined term of a Zernike polynomial.

4. The exposure apparatus of claim 3 wherein
said controller determines a coefficient in a predetermined term of a Zernike polynomial from said wavefront information, and
when determining an adjustment amount of the optical element of said projection optical system, said coefficient in a predetermined term of a Zernike polynomial determined is used.

5. The exposure apparatus of claim 4 wherein
said controller determines said adjustment amount so that an error of said projected pattern is equal to or less than a permissible value at a plurality of points in a predetermined area where said projected pattern is generated, within a field of said projection optical system.

6. The exposure apparatus of claim 1 wherein
said exposure conditions include at least an illumination condition of a pattern to be transferred onto said object.

7. The exposure apparatus of claim 1 wherein
based on said wavefront information, said Zernike Sensitivity, and data regarding a relation between an adjustment amount by said adjusting unit and variation of a coefficient in a predetermined term of a Zernike polynomial, said controller determines an adjustment amount by said adjusting unit to substantially optimize an imaging state of said projected pattern, and controls said adjusting unit based on the determined adjustment amount.

8. The exposure apparatus of claim 7 wherein
said exposure conditions include at least an illumination condition of a pattern to be transferred onto said object, and
said controller uses the least-squares method when determining the adjustment amount.

9. The exposure apparatus of claim 8 wherein
said controller determines a coefficient in a predetermined term of a Zernike polynomial from said wavefront information, and
when determining said adjustment amount, the determined coefficient in a predetermined term of a Zernike polynomial is used.

10. The exposure apparatus of claim 9 wherein
said controller determines said adjustment amount so that aberration of said projection optical system is substantially optimized at a plurality of points in a predetermined area where said projected pattern is generated, within a field of said projection optical system.

11. The exposure apparatus of claim 10 wherein
said controller determines said adjustment amount so that both a lower-order component and a higher-order component of aberration of said projection optical system are substantially optimized.

12. The exposure apparatus of claim 10 wherein
said controller determines said adjustment amount so that different aberrations of said projection optical system and different order components of each aberration are substantially optimized.

13. A device manufacturing method including a lithography process wherein
in said lithography process a device pattern is formed on an object using the exposure apparatus of claim 1.

14. An exposure method in which a pattern is transferred onto an object via projection optical system, the method comprising:
measuring wavefront information of said projection optical system with a wavefront measuring unit at least a part of which is arranged on a movable body that is arranged on an image plane side with respect to said projection optical system; and
adjusting an imaging state of a pattern generated on the object via said projection optical system, using said wavefront information and Zernike Sensitivity corresponding to exposure conditions of said object.

15. The exposure method of claim 14 wherein
said exposure conditions include an illumination condition of a pattern to be transferred onto said object, and
in determination of said adjustment amount, the least-squares method is used.

16. The exposure method of claim 15 wherein
a coefficient in a predetermined term of a Zernike polynomial is determined from said wavefront information, and
in determination of said adjustment amount, the determined coefficient is used.

17. The exposure method of claim 16 wherein
said adjustment amount is determined so that aberration of said projection optical system is substantially optimized at a plurality of points in a predetermined area where said projected pattern is generated, within a field of said projection optical system.

18. The exposure method of claim 17 wherein
said adjustment amount is determined so that both a lower-order component and a higher-order component of aberration of said projection optical system are substantially optimized.

19. The exposure method of claim 17 wherein
said adjustment amount is determined so that different aberrations of said projection optical system and different order components of each aberration are substantially optimized.

20. A device manufacturing method comprising:
forming a device pattern on a photosensitive object using the exposure method of claim 14.
